(19) United States
(12) Patent Application Publication
(10) Pub. No.: US 2026/0010808 A1
(43) Pub. Date: Jan. 8, 2026

(54) METHODS, ARCHITECTURES, APPARATUSES AND SYSTEMS FOR TRACEABILITY-AWARE ARTIFICIAL INTELLIGENCE

(71) Applicant: InterDigital Patent Holdings, Inc., Wilmington, DE (US)

(72) Inventors: Chonggang Wang, Princeton, NJ (US); Xu Li, Plainsboro, NJ (US); Efat Fathalla, Lexington, VA (US); Robert Gazda, Spring City, PA (US); Michel Roy, Candiac (CA)

(21) Appl. No.: 18/879,901

(22) PCT Filed: Jun. 28, 2023
(86) PCT No.: PCT/US2023/026493

§ 371 Date: Dec. 30, 2024

Related U.S. Application Data
(60) Provisional application No. 63/357,688, filed on Jul. 1, 2022.

(51) Int. Cl. G06N 5/045; G06N 20/00

(52) U.S. Cl. CPC G06N 5/045; G06N 20/00

(57) ABSTRACT

Procedures, methods, architectures, apparatuses, systems, devices, and computer program products enabling tracing of Artificial Intelligence, AI, tasks and host devices. A device receives, from at least one other device, an Artificial Intelligence, AI, model for installation on the device to perform an AI task, and information indicative of trace instructions based on trace criteria for the AI model requested by the device, wherein the trace information corresponds to information for tracing one or more stages of an AI pipeline associated with the AI model, installs the AI model, creates a record for the installed AI model, and transmits a message to a record device, the message comprising information indicative of at least part of the created record.

### BACKGROUND

The present disclosure is generally directed to the fields of communications, software and encoding, including, for example, to methods, architectures, apparatuses, systems directed to traceability-aware Artificial Intelligence (AI).

### SUMMARY

In a first aspect, the present principles are directed to a device comprising at least one processor configured to receive, from at least one other device, an Artificial Intelligence. AI, model for installation on the device to perform an AI task, and information indicative of trace instructions based on trace criteria for the AI model requested by the device, wherein the trace information corresponds to information for tracing one or more stages of an AI pipeline associated with the AI model, install the AI model, create a record for the installed AI model, and transmit a message to a record device, the message comprising information indicative of at least part of the created record.

In a second aspect, the present principles are directed to a method, performed by a device, comprising receiving, from at least one other device, an Artificial Intelligence, AI, model for installation on the device to perform an AI task, and information indicative of trace instructions based on trace criteria for the AI model requested by the device, wherein the trace information corresponds to information for tracing one or more stages of an AI pipeline associated with the AI model, installing the AI model, creating a record for the installed AI model, and transmitting a message to a record device, the message comprising information indicative of at least part of the created record.

In a third aspect, the present principles are directed to a device comprising at least one processor configured to receive, from another device, an Artificial Intelligence, AI, model for installation on the device to perform an AI task, and information indicative of trace instructions for the AI model, the trace instructions corresponding to information for tracing one or more stages of an AI pipeline associated with the AI model, install the AI model, and transmit a message to the other device, the message comprising information indicative of installation of the AI model on the device.

In a fourth aspect, the present principles are directed to a method, performed by a device, comprising receiving, from another device, an Artificial Intelligence, AI, model for installation on the device to perform an AI task, and information indicative of trace instructions for the AI model, the trace instructions corresponding to information for tracing one or more stages of an AI pipeline associated with the AI model, installing the AI model, and transmitting a message to the other device, the message comprising information indicative of installation of the AI model on the device.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an AI host with an AI agent with an AI task using an AI model;

FIG. 3 illustrates a general AI pipeline for supervised learning;

FIG. 4 illustrates the general Federated Learning (FL) process;

FIG. 5 illustrates two examples of Deep Learning (DL) applications for wireless networks;

FIG. 6 illustrates an example of a FL application for wireless networks;

FIG. 7 illustrates an embodiment of the proposed traceability-aware AI management architecture;

FIG. 8 illustrates a first example of the embodiment of FIG. 7 in a wireless system;

FIG. 9 illustrates a second example of the embodiment of FIG. 7 in a wireless system;

FIG. 10 illustrates an embodiment of a method of traceability-aware AI Host (AIH) registration;

FIG. 11 illustrates another embodiment of a method of traceability-aware AIH registration;

FIG. 12 illustrates an embodiment of AIH-Initiated Traceability-Aware AI Task Deployment;

FIG. 13 illustrates an embodiment of AI Manager (AIM)-Initiated Traceability-Aware AI Task Deployment;

FIG. 14 illustrates an embodiment of AIH-Initiated Traceability-Aware FL Task Deployment;

FIG. 15 illustrates an embodiment of AIM-Initiated Traceability-Aware FL Task Deployment;

FIG. 16 illustrates a method for an AI Model Producer (AIMP) to register an AI model to an AI Repository (AIR) according to an embodiment;

FIG. 17 illustrates a method of AIR-assisted traceability-aware model discovery and deployment according to an embodiment;

FIG. 18 illustrates a method of AIM-coordinated traceability-aware AI model discovery and deployment according to an embodiment;

FIG. 19 illustrates a method of AIMP-initiated traceability-aware model discovery and deployment according to an embodiment;

FIG. 20 illustrates a first example of deployment of traceability-aware AI task and model management in 3GPP cellular networks;

FIG. 21 illustrates a second example of deployment traceability-aware AI management in 3GPP cellular networks;

FIG. 22 illustrates a third example of deployment traceability-aware AI management in 3GPP cellular networks;

FIG. 23 illustrates an example service flow for traceability-aware AI model discovery and deployment; and

FIG. 24 illustrates an example of a method of traceability-aware AI management including task and model deployment in the framework of ETSI Securing Artificial Intelligence (SAI).

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

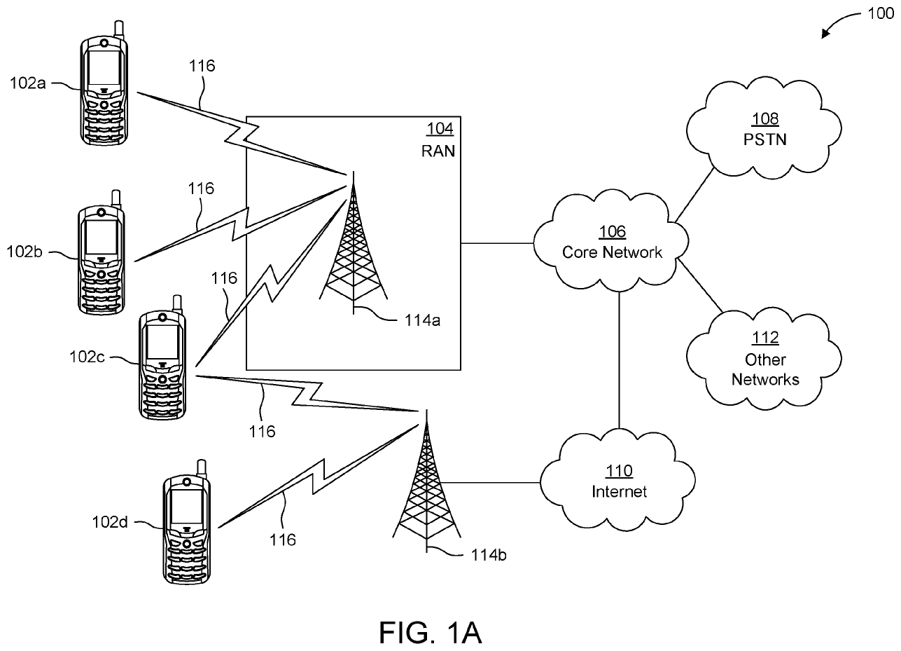

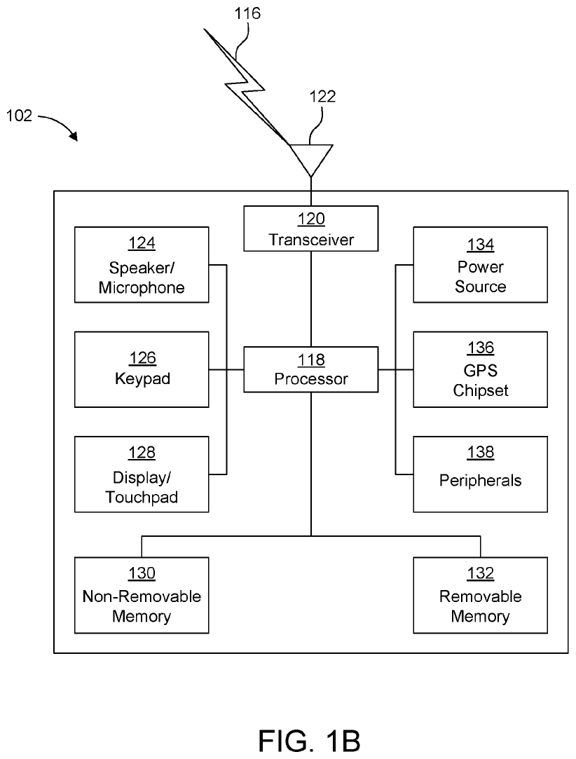

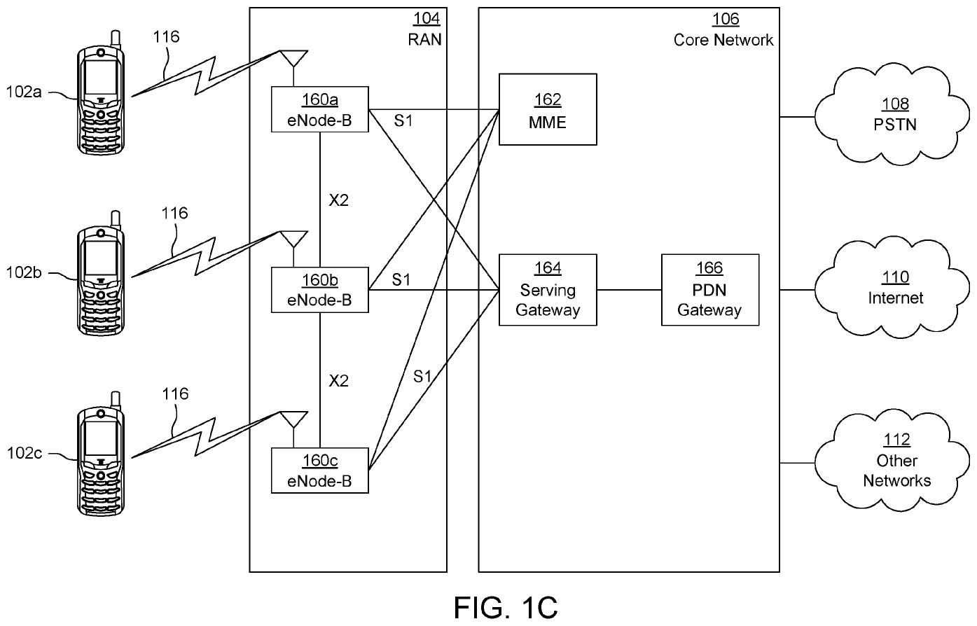

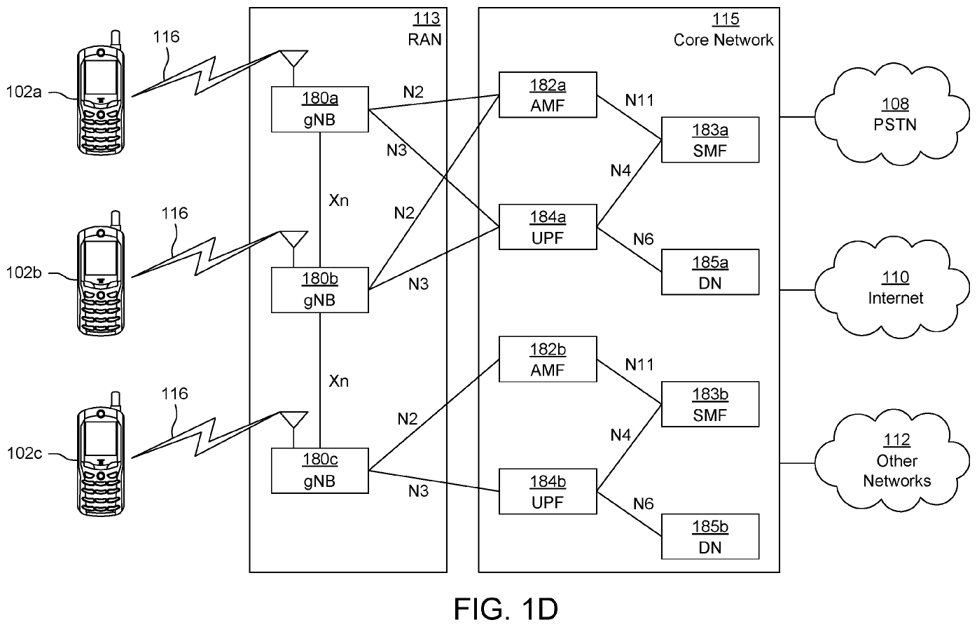

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a CE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an e Node-B (cNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRU's 102a, 102b, 102c over the air interface 116. In an embodiment, the e Node-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the cNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the e Node-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-e Node-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHZ to 928 MHZ. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include g NBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, g NBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

### Blockchain Technology

Blockchain technology jointly leverages and builds on top of existing techniques such as cryptography, hashing, Merkle tree, distributed ledgers, peer-to-peer networking, and consensus protocols. Blockchain technology integrates them into a system (i.e., a blockchain system) that can provide advanced features such as decentralization, immutability, transparency, and security. Applications using and/or supported by a blockchain system are referred to as blockchain applications. A blockchain system is underpinned by blockchain networks composed of participating blockchain nodes Each blockchain node hosts one or more distributed blockchains (i.e., a form of distributed ledgers) and participates in the blockchain system. For example, blockchain nodes can peer-to-peer networking to broadcast blockchain transactions and blocks among themselves. Blockchain nodes also perform consensus protocols to reach distributed trust without relying on a centralized party. A blockchain transaction can for example be a digital representation of a real-world transaction, a digital record of physical assets, a digital record of a physical event, a digital record of any action in an information system, a digital payment, and/or a digital smart contract. A block groups multiple blockchain transactions. A blockchain is a data structure chaining a growing number of blocks. Herein, blockchain technology is used as a non-limiting example of distributed ledger technology; the present principles can thus apply not only to any specific blockchain technology, but also to distributed ledger technology such as Permissioned Distributed Ledger [see ETSI GR PDL 003 V1.1.1 (2020 December); Permissioned Distributed Ledger (PDL); Application Scenarios].

The general workflow of a blockchain system includes five steps.

Step 1: Initiating Transactions. Each blockchain client or blockchain user generates new transactions independently. Each blockchain user has a user or account identifier, typically a hash of the user's public key that is used to sign the new transaction. The signed new transaction is then sent to the blockchain network.

Step 2: Broadcasting and Verifying Transactions. A new transaction is first received by a small number of blockchain nodes, which verify its integrity using the user's public key that is included in the transaction. If the validity of new transaction is successfully verified, the new transaction is relayed and broadcasted within the blockchain network. Eventually, all blockchain nodes will receive and have a copy of any newly generated, valid transaction.

Step 3: Building New Blocks. Specific building blockchain nodes (referred to as Mining Nodes or Full Blockchain Nodes) start to group a plurality of newly generated and pending transactions to generate a new block. The new block will include a block header and a block body. The block header generally includes a hash of the previously confirmed block, and a hash of all included transactions (e.g., Merkle tree). Dependent on the consensus protocol, the block header may contain additional information. The block body contains the content of all included transactions. Each building blockchain node independently attempts to create a new block.

Step 4: Validating New Blocks based on a Consensus Protocol. In step 3, building blockchain nodes independently attempted to create a new block. They run the same consensus protocol (e.g., Proof-of-Work in a Bitcoin system) and reach an agreement on who (i.e., a winner) is allowed to insert a block in the existing blockchain. The winner of the consensus protocol sends its newly generated block to the blockchain network. This new block is broadcasted and all building blockchain nodes receive and verify it.

Step 5: Updating Blockchain. After the newly generated block is verified in step 4, it is successfully appended to the existing blockchain, linked to it since it contains a hash of the previous block (i.e., the last block of the previous blockchain).

### AI Introduction

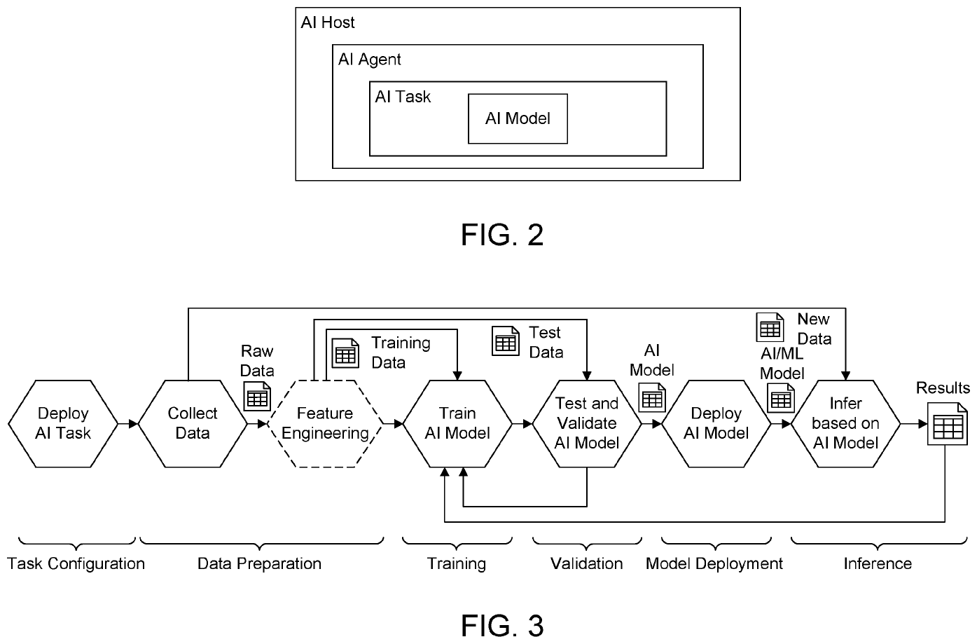

An AI system includes one or more AI agents, which learn and/or exploit an AI model based on at least one AI scheme such as deep learning, federated learning, and reinforcement learning AI agents usually reside in different physical or logical nodes (e.g., devices, servers, a virtual machine in the cloud), referred to as AI Hosts (AIHs). Each AI agent usually hosts and runs an AI task, which for example is a task for learning an AI model according to an AI algorithm (e.g., a deep learning algorithm, a federated learning algorithm, a reinforcement learning algorithm) or a task for using an AI model to infer knowledge. Deep learning and reinforcement learning usually uses one AI agent, while federated learning utilizes multiple AI agents working collaboratively to learn an AI model, which could be a deep neural network model and a policy model for reinforcement learning. Federated learning can be used to solve various types of learning tasks including but not limited to deep learning and reinforcement learning. An AI algorithm could be supervised by relying on tagged training data or unsupervised without the use of any tagged data. FIG. 2 illustrates an AI host with an AI agent with an AI task using an AI model.

Herein, the process of (re-)installing an AI task (e.g., a piece of software code plus data) on an AI agent on an AI host is referred to as ‘AI task deployment’, while ‘AI model deployment’ refers to the process of transferring and/or (re-)installing an AI model to an existing AI task. Note that when an AI task has been deployed on an AI agent, AI agent and AI task may be used interchangeably in this description.

Herein, ‘model’ and ‘AI model’ are used interchangeably and mean the same thing unless explicitly stated; similarly, ‘task’ and ‘AI task’ are used interchangeably and mean the same thing unless explicitly stated.

FIG. 3 illustrates a general AI pipeline for supervised learning. The pipeline typically includes multiple stages: 1) Task configuration that includes the deployment of AI agents/tasks by an AI application or user; 2) Data preparation that includes data collection and, optionally, feature engineering/extraction; 3) Training for learning an AI model; 4) Validation for testing and validating the learned AI model; 5) Model deployment for deploying and transferring the validated AI model; and 6) Inference for inferring and predicting future knowledge using new data as input (referred to as input data for inference). The results (e.g, outcome) from the inference could be leveraged to action or trigger going back to training in order to re-train the AI model.

Depending on AI deployment choices, an AI agent could be: 1) an AI Agent for Learning (AIA4L) responsible for learning an AI model; 2) an AI Agent for Inference (AIA4I) using a learned AI model for inference and predication; and 3) an AI Agent for Learning and Inference (AIA4LI), combining the former two. AI model transfer generally occurs between an AIA4L and an AIA4I or between multiple AIA4LI.

### Deep Learning

Deep Learning (DL) is a specialized supervised machine learning (ML) that uses Deep Neural Networks (DNN) as is well known in the art. A DNN typically includes an input layer, multiple hidden layers, and an output layer. Each layer (in particular the hidden layers) has a number of artificial neurons, which are connected to neurons in the previous layer and to neurons in the next layer. A connection between two neurons in two neighboring layers is assigned a weight, which indicates to what extent the neuron in the prior layer will influence the neuron in the next layer. Training a DNN includes repeated feedforward and backpropagation.

Feedforward: input data passes through the DNN from the input layer to the output layer to generate an output (e.g., a scalar or a vector).

Backpropagation: the generated output is used to calculate a loss according to a pre-defined loss function. The loss is then used to adjust weights between two neighboring layers all the way backward from the output layer to the input layer, using gradient descent. The learned AI model in deep learning is the set of weights connecting all neurons in the DNN. A deep learning system can be deployed as one single AI agent (i.e., AIA4LI) or as multiple separate AI agents (e.g., one AIA4L and multiple AIA4I).

DNNs can provide a good approach for learning or approximating a non-linear function mapping input to output. However, data items used for training a DNN should have no or small correlations to achieve good performance (e.g., learning accuracy). DNNs can be used for solving many machine learning problems such as prediction and classification. Different types of DNNs have been designed for different applications. For example, Convolutional Neural Networks (CNNs) have been successful for computer vision and acoustic modeling, while Recurrent Neural Networks (RNNs) and Long Short-Term Memory (LSTM) are good tools for natural language processing.

### Federated Learning

Federated Learning (FL) is a framework for distributed ML or distributed AI. In FL, training data is maintained locally at multiple distributed Federated Learning Clients (FLCs) (e.g., mobile devices). Each FLC performs local training (e.g., deep learning), generates local model updates, and sends local model updates to a Federated Learning Server (FIS). The FIS, as a central entity, aggregates local model updates from FLCs and generates global model updates, which are sent to participating FLCs for the next training round. Example advantages of federated learning can include: 1) improved data privacy-preservation since training data stays at FLCs; 2) reduced communication overhead since it is not required to collect/transmit training data to a central entity; and 3) improved learning speed since model training now leverages distributed computation resources at FLCs. However, FL needs to transmit model updates between the FLS and FLCs, which introduces additional communication overhead compared to centralized machine learning. Also, FL requires data at all FLCs to follow an Independent and Identical Distribution (IID) (i.e., IID-data) to achieve good learning performance. In addition, FL inherits potential security issues and threats such as data poisoning and model poisoning attacks. In fact, the FLS hosts an FL agent for learning (i.e., AIA4L), while each FLC has an FL agent that could be for both learning and inferring (i.e., AIA4LI). Note that both FLS and FLCs are AIHs.

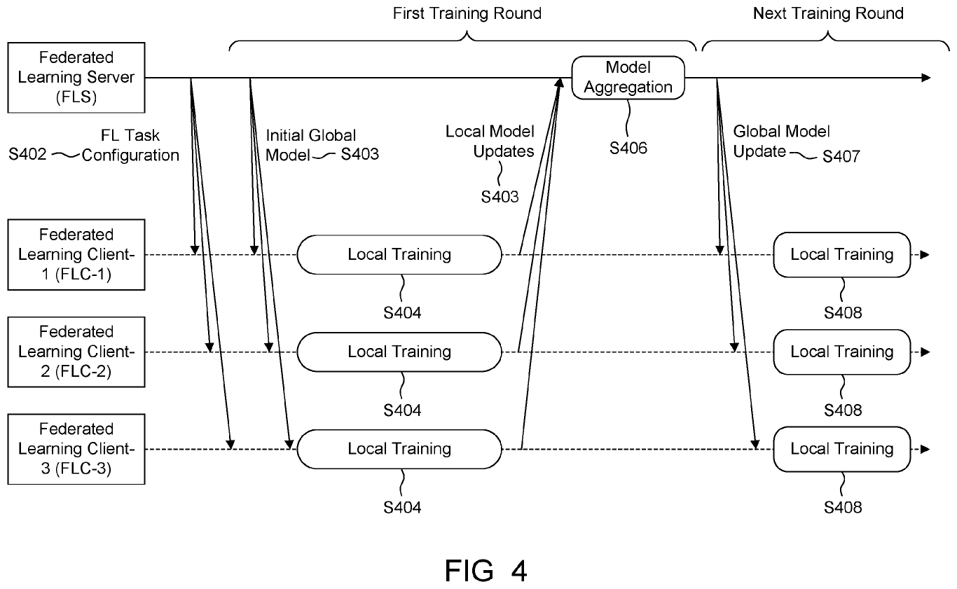

FIG. 4 illustrates the general Federated Learning process, where, for example, the FLS could be an NWDAF in 5G and FLCs could be UEs. The FLS and FLCs jointly take the following steps to perform an FL task.

Step S401 (not illustrated): The FLS selects a set of FLCs to participate in a FL task. In the illustrated example, FLCs 1-3 are selected.

Step S402: The FLS configures (e.g., deploys or instructs the FLCs to start local training of an already deployed FL task) the FL task to each selected FLC.

Step S403. The FLS sends an initial global model to each selected FLC.

Step S404: Each FLC independently trains the global model based on the received initial global model and its local data.

Step S405: After the local training round in step S404, each FLC generates a local model update that it sends to the FLS.

Step S406: The FLS receives local model updates from the selected FLCs, aggregates them, and generates a global model update. In synchronous FL, the FLS waits until it has received local model updates from all participating FLCs before performing the aggregation. In asynchronous FL, the FLS can start the aggregation upon reception of the local model updates from a subset of participating FLCs.

Step S407 is similar to step S403, but the FLS sends the global model updates to selected FLCs. It is noted that the FLS can change the set of selected FLCs between training rounds, for example retaining one or more FLCs of the previous set.

Step S408 is similar to Step S404, i.e., the selected FLCs independently trains the global model based on the received global model update.

Step S409 (not illustrated) is similar to step S405: the FLCs send local model updates to the FLS. The FLS can then generate a new global model update, which the FLS can send to FLCs as the beginning of a further iteration.

### AI-Related 3GPP Standards

3GPP TS 22.261 [3GPP TS 22.261 V18.5.0 (2021 December); Service requirements for the 5G system; Stage 1 (Release 18)] specifies AI model transfer requirements for three types of AI operations: 1) AI operation splitting between AI endpoints; 2) AI model/data distribution and sharing over 5G system (5GS); and 3) distributed/federated learning (FL) over 5GS.

3GPP TR23.700-80 [3GPP TR 23.700-80 v0.3.0 (2022 May) Study on 5G system support for AI-based services (Release 18)] aims to define intelligent transmission support for AI-based services in 5GS. It will focus on 5GS architectural and functional extensions so that service providers can leverage 5GS as the intelligent transmission platform to support AI-based services.

TR 23.700-80 has a number of main objectives: study the possible architectural and functional extensions to support the application-layer AI operations defined in TS 22.261: study possible QoS, policy enhancements to support Application AI operational traffic while supporting regular (non-Application-AI) 5GS user traffic; and study whether and how 5GS provides assistance to an AF and the UE for the AF and UE to manage the FI, operations and model distribution/redistribution (e.g., FL members selection) to facilitate collaborative application AI based on Federated Learning operations between the application clients running on the UEs (i.e., FLCs) and the Application Servers (i.e., the FLS).

In addition, 3GPP recently approved a new release-19 study item [3GPP SA1 S1-220183, “Study on AI Model Transfer Phase2,” 3GPP SA WG1 Meeting #97-e, Feb. 14-24, 2022] to study the use cases and potential service and performance requirements for distributed AI training/inference involving direct device connection, which has the following two objectives: Distributed AI training/inference based on device-to-device connection; and charging and security aspects.

### ETSI SAI

ETSI GR SAI 0010 [ETSI GR SAI 0010 V0.0.1 (2022 January); Securing Artificial Intelligence (SAI); Traceability of AI Models] aims to study the role of AI traceability in securing AI and exploring the potential issues related to sharing and re-using models across different tasks or various industry-related applications. The scope of AI traceability includes, but is not limited to, discovering potential threats, and their associated remediations. Further AI traceability can improve the decisions to where AI traceability would be applicable, protect ownership rights of AI creators as well as to protect origin of the model verification, ensure the model integrity, or discover its purpose.

### Wireless AI Use Cases

Two wireless AI use cases are described, including Deep Learning (DL) in wireless networks and federated learning for wireless networks. In both use cases, there is a need to deploy AI tasks (i.e., deep learning and federated learning) and AI models from an edge data network (or core network) to wireless devices. As ETSI GR SAI 0010 shows, it can be important to provide traceability to the deployed AI tasks and AI models, which requires AI tasks and AI models to be traced during their lifecycle, which can be leveraged as the foundation to build auditable, explainable, and trustworthy AI.

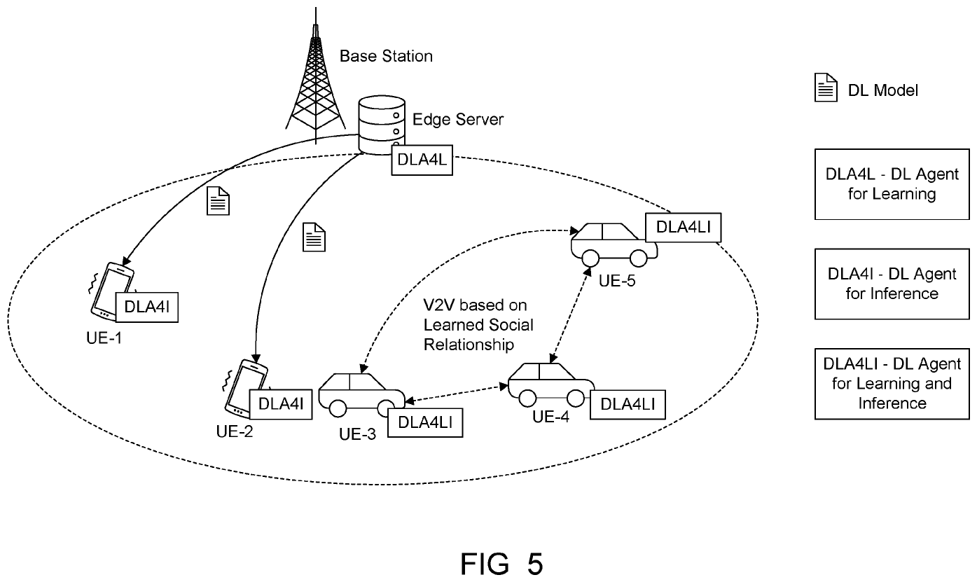

FIG. 5 illustrates two examples of DI, applications for wireless networks, where a UE hosts a DL agent, which hosts an AI task. The AI task uses a DL model, learns a DL model, or both. The DL agent at each UE is pre-installed or run-time deployed. Note that in FIG. 5, DL could be replaced with another type of AI algorithm. In this use case, the base station and each UE is an AIH.

DL for Radio Resource Allocation: DL is used to learn radio resource allocation between UE-1 and a base station. For example, a DL agent (i.e., DLA4L) is deployed in an edge server co-located with the base station. The DL agent is configured with an AI task to learn radio resource allocation policy Based on historical transmission information about UE-1 (and/or other UEs) and the base station, the DL agent learns a model for allocating radio resource for UE-1 (and/or UE-2). Then the learned model is deployed to UE-1 (and/or UE-2). At each new time slot, the DL agent at UE-1 and/or UE-2 (i.e., DLA4I) can use the model to decide on new radio resources for upstream transmission. Such an AI-based approach could capture wireless channel dynamics and the changing traffic over a wireless channel more quickly and accurately, and in turn lead to improved radio resource utilization.

DL for Vehicle-to-Vehicle Content Dissemination: Three vehicles (i.e., UE-3, UE-4, and UE-5) are within the same vicinity and can communicate with each other directly for sharing content (e.g., a media file). To disseminate content more efficiently, each vehicle is installed with a DL agent (i.e., DLA4LI) to, for example, learn social relationships and content popularity.

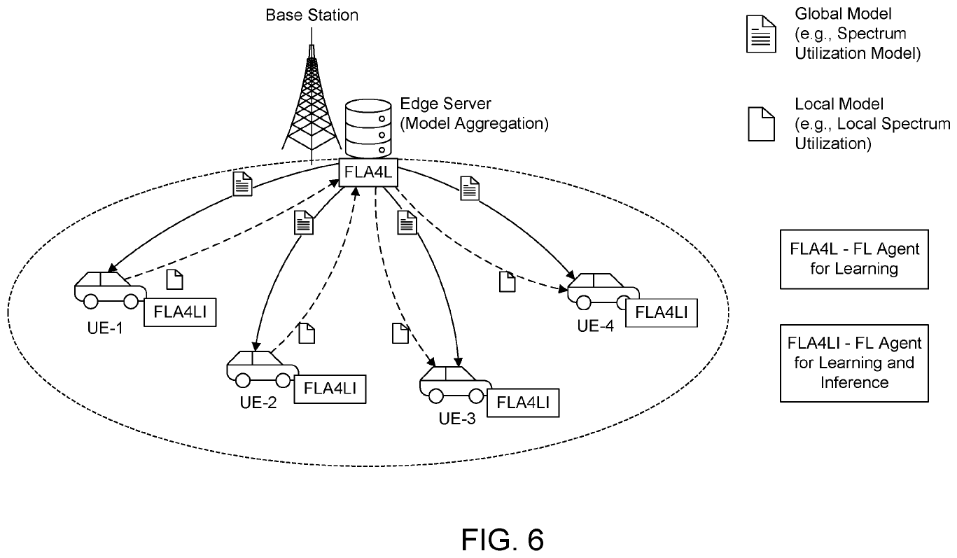

FIG. 6 illustrates an example of a FL application for wireless networks, where each UE hosts an FL agent, which collaboratively participates in learning a global model and uses the learned global model for inference. The FL agent at each UE is pre-installed or deployed at run-time. In this case, each UE and the edge server is an AIH.

FL for Spectrum Management: FL is used to learn an accurate spectrum utilization model. Each UE (i.e., UE-1, UE-2, UE-3, and UE-4) hosts an FL agent (i.e., FLA4LI), which acts as an FIC to generate a local model update. Local model updates are sent to an edge server, which has an FL agent (i.e., FLA4L) mainly responsible for aggregating local model updates from UEs to generate a global model update. The global model update is sent to the UEs to continue the next training round until the global model converges. Then, the converged final global model is transmitted to the FL agent at each UE, and each UE uses the FL agent with the final global model to manage its local spectrum access.

In the aforementioned AI use cases for wireless networks, a UE typically hosts an AI agent (e.g., AIA4L, AIA4I, or AIA4LI), which learns a model, uses a model for knowledge inference, or participates in both. To deploy a particular AI scheme for wireless networks, AI agents (e.g., a piece of software) first need to be installed on corresponding UEs and/or other network nodes such as edge servers. Then, an AI agent starts to train an AI model, which may demand the collection of training data. After the AI model is trained the AI agent needs to test and validate the AI model against test data and validation data, before the AI model is deployed (e.g., transferred from one AI agent to another AI agent). Finally, the deployed or transferred AI model can be used to infer and predict future knowledge from real data and, based on this, take action.

It can be critical to make this entire AI system trustworthy, especially within a wireless environment, where distributed parties exist and potential threats to AI agents and AI models, such as data poisoning attacks, could occur. As such, one approach is to trace and document the entire AI system, referred to as AI traceability. Such a requirement on AI traceability may come from AI agents, AI applications, or AI users. However, tracing the entire AI system may introduce tremendous overhead, especially in the communication systems where network delay is a significant parameter. In addition, it may be unnecessary to trace each stage of the AI system. For example, in federated learning, to trace the training stage may be more important than the inference stage, since the training stage is performed by multiple distributed nodes with more potential threats or risks. In general, efficient and flexible AI traceability schemes may be needed, especially for wireless AI use cases. According to the present principles, AI trace information or AI trace records or AI trace documents are information generated from tracing an AI system or an AI pipeline.

AI management according to the present principles mainly refer to multiple stages/operations/procedures such as, but not limited to, AI host registration for registering an AIH to a repository, AI task deployment, AI model registration, AI model discovery, and AI model transfer/deployment. Existing AI management procedures are oblivious to traceability, which may result in inefficient AI management, reduced AI reliability and ultimately poor user trust in AI. For example, an AI user may need to discover an AI model supporting traceability, which can provide better transparency and trustworthiness to the AI user. However, traceability-oblivious AI model registration cannot indicate whether an AI model supports traceability or not and in turn it cannot meet the AI user's need. In addition, if the traceability is not supported when an AI task/model is deployed, the AI task/model may need to be removed and re-deployed later when the traceability is demanded. In the worst case, an AI model/task due to the lack of traceability might need to be (re) deployed and/or re-trained multiple times, which introduces extra overhead in terms of repeated AI management procedures and consumed resources. Moreover, each of these AI management stages/procedures may be conducted by different physical and/or logical nodes; for instance, training and knowledge inference in FIG. 5 for radio resource allocation are done by the base stations and UEs, respectively. These physical and/or logical nodes generally have different resources (e.g., computing power), which should be jointly considered in a unified fashion to enable traceability-aware AI management.

Given the aforementioned discussion, the following issues are identified:

### Issue #1: How to Design an AI Management Architecture Capable of Flexibly Tracing the AI Pipeline?

Real-world AI systems (e.g., an FL system) may be dynamic and heterogenous, for instance, in terms of the types of AI tasks, the volume of available training data, the number of involved AI agents, and the capability of involved AI agents. A traceability-aware AI management architecture should be applicable and adaptable for different AI systems, different AI tasks, and different AI agents. Such a flexible traceability-aware AI management architecture could also be able to and/or be extensible to support different levels of traceability (e.g., to trace an entire AI pipeline or to trace one stage of the pipeline) using different but appropriate traceability instructions and generate suitable AI traced records as needed. As an example, such a flexible traceability-aware AI management architecture can provide common methods/interfaces/procedures, which can be leveraged to enable the traceability for different AI systems based on their requirements.

To design a flexible traceability-aware AI management architecture, the following issues are considered.

### Issue #2: Traceability-Aware AI Host Registration.

When an AI host registers itself to an AI repository entity, a method can represent the trace capability of the AI host and how to expose its trace capability to other entities.

### Issue #3: Traceability-Aware AI Task Deployment.

When an AI task is deployed, it can be important to configure, explicitly and concurrently, trace instructions for the AI task, so that the AI task can automatically trace itself according to the configured trace instructions.

### Issue #4: Traceability-Aware AI Model Registration.

When an AI model is registered to an AI repository entity, a method can configure or associate proper trace instructions with the AI model.

### Issue #5: Traceability-Aware AI Model Discovery and Deployment.

When an AI host discovers and requests to install/host an AI model, a method can guarantee the trace instructions of the discovered AI model match the trace capabilities of the AI host.

### Overview

Herein, the following terms are defined as follows.

AI Model: The learned model (e.g., a set of parameters) from training data, which can accurately model or capture patterns in the training data.

AI Task: A task for training an AI model and/or using a trained AI model. An AI task can be deployed to an AI host as a piece of software with relevant information (e.g., an initial AI model, training data, and/or input data).

AI Agent: An entity capable of running an AI task. An AI agent is hosted by an AI host, while an AI host can host multiple AI agents. An AI agent can produce/train an AI model and/or use a trained AI model to infer knowledge.

AI Host: An entity with both software and hardware to support one or multiple AI agents.

AI Repository: An entity that allows the registration of AI hosts and/or AI models, the discovery of AI hosts and/or AI models, etc.

AI Pipeline: A set of stages for executing one or multiple AI tasks. An AI pipeline may include one or more (e.g., all) of task configuration, data preparation, training for learning an AI model, validation for testing and validation of the learned AI model, model deployment for deploying and transferring the validated AI model, and inference for inferring and predicting future knowledge using new data as input.

AI Trace Manager: An entity that manages whether, when, how, and/or what to trace an AI pipeline. AI Trace Manager may generate, configure, update, remove trace instructions for/from an AI host, an AI agent, an AI task, and/or an AI model.

Trace Instructions: The specifications or conditions or criteria or policies or rules for describing whether, when, how, and/or what to trace an AI pipeline. An AI agent (or an AI host) generates trace records according to configured trace instructions. Trace instructions can be called as trace conditions, trace criteria, trace commands, trace rules, and/or trace policies.

AI Manager: An entity that manages AI tasks, AI agents, AI hosts, AI repositories, and even AI trace managers.

Distributed Storage System (DSS): A system that stores information (e.g., the information about an AI model, the information about an AI host, training data, inferred knowledge, trace instructions, trace records, etc.). DSS could be a distributed database, distributed ledgers, a blockchain system, etc.

### Traceability-Aware AI Management Architecture

AI management refers to operations for managing AI hosts, AI tasks, and AI models such as AI host registration, AI task deployment and AI model deployment. Conventional AI management solutions used to trace an AI task or an AI model after they are deployed, are referred to as a tracing-after-deployment approach. The present principles propose a more proactive approach, which enables or embeds AI traceability concurrently during the AI management operations. For example, the tracing-after-deployment approach may fail if a deployed AI task does not support AI traceability. Moreover, the present principles can avoid or reduce extra overhead, which the tracing-after-deployment approach may need, for instance, to modify or re-deploy a deployed AI task in order to support AI traceability. A traceability-aware AI management framework is proposed as a proactive trace approach that couples traceability enablement and AI management by jointly considering what an AI task/model needs to be traced (i.e., trace instructions) and what resources an AI host can allocate or afford for tracing the AI task/model it hosts (i.e., trace capability). The proposed traceability-aware AI management framework can provide essential and common functionalities and interfaces (e.g., configure trace instructions when configuring an AI task), which are not limited to a particular AI system/task/model. Moreover, the proposed traceability-aware framework allows to configure appropriate trace instructions to different AI hosts, dependent on their trace capability and the characteristics of AI tasks/models they host. As such, it can be possible to collect more useful traced information about an AI pipeline.

The proposed traceability-aware AI management features at least one of the following functions.

An AI Trace Manager (AITM) can provide and determine trace instructions (e.g., to generate an AI trace record for each training round) for tracing an AI task/model, based on the trace instructions of the AI task/model and the trace capability (e.g., the available storage for storing generated AI trace records) of an AI Host (AIH) that hosts the AI task/model. Note that an AIH may host one or multiple AI agents, which could be AIA4L, AIA4I, and/or AIA4LI.

An AIH can register its trace capability to an AI Repository (AIR), which can be exposed to and discovered by both entities such as an AI Manager (AIM). An AIH could be an AI Model Producer (AIMP) or an AI Model User (AIMU); an AIMP may host one or multiple AIA4L or ALA4LI, while an AIMU may host one or multiple AIA4I. The AIR can publish each registered AIH to a Distributed Storage System (DSS) such as a distributed ledger system.

The AIM can enable traceability simultaneously when it deploys an AI task to an AIMP by configuring trace instructions with the AI task. The trace instructions match the trace capability that the AIMP can support.

The AIM can enable traceability simultaneously when it deploys an AI task to an AIMU by configuring trace instructions with the AI task. The trace instructions match the trace capability that the AIMU can support.

The AIR can also maintain a list of AI models, which AIMPs generate and register to the AIR. When an AIMP registers an AI Model, the AIMP can configure trace instructions for the AI model. An AIMU can come to the AIR for discovering appropriate AI models with trace instructions matching the trace capability of the AIMU. The AIR can publish each registered AI model to a DSS such as a distributed ledger system.

When an AI task with trace instructions has been installed to an AIMP, the AIMP runs the AI task and in the meantime generates AI trace records according to the trace instructions configured with the AI task. The AI trace records are sent to a DSS, such as a distributed ledger system.

After an AI task and the corresponding AI model with trace instructions are installed to an AIMU, the AIMU runs the AI task and in the meantime generates AI trace records according to the trace instructions configured with the AI task/model. The AI trace records are sent to a Distributed Storage System (DSS), such as a distributed ledger system.

The AIM can actively discover a new AI model and push it to an AIMU with new trace instructions.

The AIMP can pre-register a partially trained AI model with trace instructions to an AIR or announce it to AIMUs. After the AI model is fully trained, the AIMP can actively push the AI model to the AIR or AIMUs.

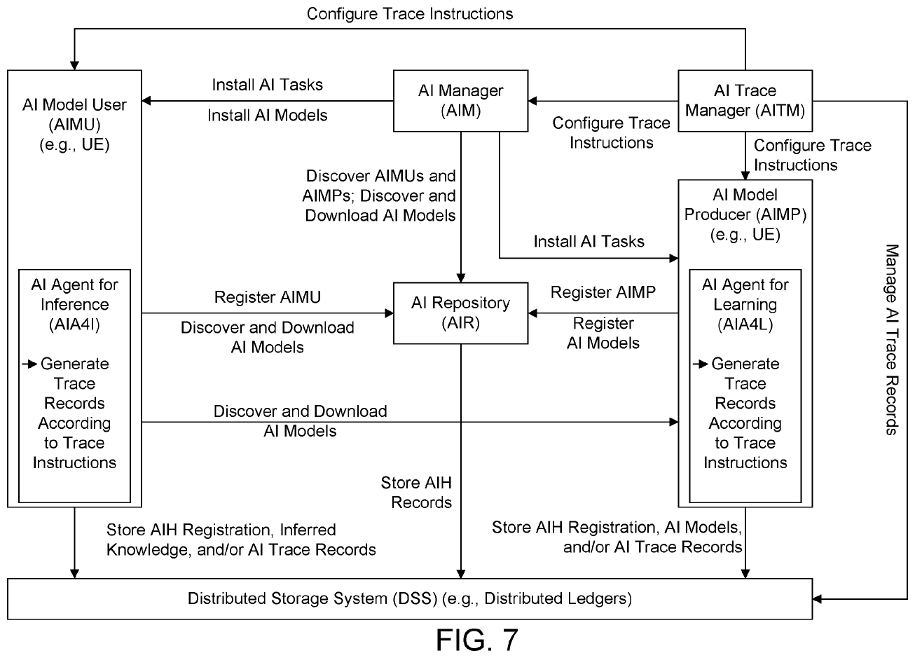

FIG. 7 illustrates an embodiment of the proposed traceability-aware AI management architecture, which includes a number of logical entities: AI Manager (AIM), AI Trace Manager (AITM), AI Repository (AIR), AI Model Producer (AIMP), AI Model User (AIMU), and Distributed Data System (DDS). A salient feature of this architecture is the integrated AI pipeline management and traceability through collaborative interactions among those logical entities. In other words, AI traceability can be efficiently enabled in the process of managing AI tasks and models in the proposed architecture. Note that an AIMU and an AIMP in FIG. 7 could be combined to host and support an AIA4LI agent.

AI Task: An AI task can be installed on an AI Model Producer (AIMP) or an AI Model User (AIMU), as a part of the AI agent at the AIMP or the AIMU. The AIMP has an AI Agent for Learning (AIA4L), which is used to: 1) train and generate an AI model; and 2) generate AI trace records according to installed trace instructions. In contrast, the AIMU has an AI Agent for Inference (AIA4I), which is used to: 1) infer knowledge based on an installed AI model and input data for inference; and 2) generate AI trace records according to installed trace instructions. The AIMU and the AIMP could be co-located within the same physical node such as a UE or an edge server. To support AI traceability and AI management, each AI agent (or AI task executor) may support new Application Programming Interfaces (APIs).

As an example, the following three APIs, that could be implemented as a single API, can be used to communicate with the AI Task. When implemented as a single API, the request can indicate which of the following API functions are triggered.

TRACE-INSTRUCTION-CONFIG-API: This API allows other entities such as AI Manager (AIM) or an AI Trace Manager (AITM) to configure one or multiple trace instructions to the AI agent. When the AI agent runs the corresponding AI task, the AI agent will generate AI trace records according to the trace instructions.

TRACE-RECORD-MGMT-API: This API allows other entities to retrieve/delete the generated AI trace records or allow the AI agent to actively push the generated AI trace records to other entities (e.g., a DSS or an AIM) via this interface.

MODEL-MGMT-API: An AI task for inferring knowledge (i.e., AIA4I) may have this additional API, which allows other entities (e.g., an AIM, an AIH) to dynamically configure/update/retrieve the AI models used by the AI agent. This API may configure both the AI model and associated trace instructions concurrently, especially when TRACE-INSTRUCTION-CONFIG-API is unavailable.

Each API can for example be described using the following API information (referred to as API-Info): Endpoint of the API for communication (e.g., URI, FQDN, IP Address, etc.); and transport information of the API such as type of protocol (e.g., REST/HTTP, CoAP, Topic-based, Pub Sub, RPC, WebSocket, etc.), security-related information (e.g., security credential, certificates, public keys, etc.), version, etc.

API-Info of each API can be shared with and/or configured by another entity (e.g., an AI manager, an AI trace manager, an AI repository, etc.).

AI Model: An AI model can be generated by an AIMP, which has an AI agent running an AI task to train an AI model (e.g., a set of parameters/weights for a DNN) according to the corresponding AI algorithm (e.g., backpropagation for a DNN). A standalone AIMP could produce an AI model by itself. Multiple AIMPs can also collaboratively train an AI model and trace instructions can be defined and created by the AIM for this case. For example, in a FL setting, the FL server and FL clients work together to generate a converged global AI model. A generated AI model can be used by an AIMU to infer knowledge based on real data inputs, and multiple AIMUs can use the same AI model with different data inputs. The content of an AI Model can contain its own trace instructions and requirement (Trace-Instructions), based on which AI task is using this AI model, each AI task can generate AI trace records accordingly. The status of an AI model at an AIMP can for example be: Fully Trained—The AI model is fully trained and validated, and it can be deployed to infer knowledge, 2) Partially Trained—The AIMP has not finished training or validating the model and it cannot be deployed or used to infer knowledge.

AI Trace Instruction (ATI): An AI trace instruction describes how the AI process and resulting information (e.g., model weights, inference results, etc.) from an AI task should be recorded for traceability and under which conditions. AI Trace Instruction and Trace Instruction are interchangeably used in this disclosure.

AI Manager (AIM): An AIM maintains a list of AI tasks. The primary objective of the AIM is to enable AI traceability while managing AI tasks and models. Specifically, the AIM is responsible for requesting and receiving trace instructions from an AI Trace Manager (AITM), discovering an AI Model Producer (AIMP) from the AIR, installing an AI task to the AIMP, discovering, and downloading an AI model from the AIR, discovering an AI Model User (AIMU) from an AI Repository (AIR), and installing AI tasks and AI models to the AIMU.

As an example, first, the AIM requests or receives trace instructions from an AI Trace Manager (AITM) for one or multiple AI tasks. The AITM could also actively retrieve AI tasks from the AIM and in turn configure appropriate trace instructions for each task. A trace instruction could be applied to one or multiple AI tasks. As a result, each trace instruction contains a list of AI-Task-IDs indicating the AI tasks to which the trace instruction can be applied. One AI task could be applied or enforced with multiple trace instructions.

Then, the AIM determines to install a selected AI task to an AIMP. The AIM discovers the AIMP for the selected AI task from the AIR. The AIM generates an AI task package, which include the AI task itself (i.e., software code with any necessary configuration files) and applicable trace instructions as received from the AITM. The AIM sends the AI task package to the AIMP, which will install the AI task package locally to its AI agent. After that, the AIM and the AITM can re-configure new trace instructions to the AI task via its TRACE-CONFIG-API.

Similar to installing the AI task to the AIMP, the AIM can install another AI task to an AIMU with trace instructions embedded in an AI task package to be sent to the AIMU. The AIM can discover the AIMU from the AIR. The AI task package sent to the AIMU can contain one or multiple AI models, which the AIM can discover and download from the AIR. If the AI task package does not contain any AI model, the AIMU can discover and download an AI model from the AIR. Alternatively, the AIM or the AIR can configure AI models to the installed AI task at the AIMU via its MODEL-MGMT-API.

AI Trace Manager (AITM): An AITM enables AI traceability as a part of the AI management. The AITM could be a management application and could be implemented as a part of the AIM. The AITM is mainly responsible for configuring trace instructions for one or multiple AI tasks via an AIM, an AIMP, and/or an AIMU. The AITM can update or delete any configured trace instructions from the AIM, the AIMP, and/or the AIMU. In addition, the AITM can manage AI trace records stored in Distributed Storage System (DSS).

The AITM can discover an AI task from the AIM and determine applicable trace instructions for the AI task according to provisioned policies. Alternatively, the AIM can request and retrieve trace instructions for an AI task from the AITM.

The AITM can update and remove any configured trace policies for an AI task installed at the AIMP via its TRACE-MGMT-API.

The AITM can update and remove any configured trace policies for an AI task installed at the AIMU via its TRACE-MGMT-API.

The AITM can query, retrieve, aggregate, and even revise AI trace records as stored in a DSS.

AI Repository (AIR): An AIR maintains a list of registered AI models. The AIR can also maintain a list of potential AIMP and AIMU. The AIR is mainly responsible for the following operations.

An AIMP can register itself and/or its models to the AIR indicating: 1) if it can be used as an AIMP and can host an AI task to train an AI model; and/or 2) if it has any trained AI models to be registered with the AIR. During this registration with the AIR, the AIMP can also indicate its trace capability (Trace-Capability), which may be described as the amount of the available computing/storage/communication resources that the AIMP can allocate for tracing AI tasks at the AIMP.

An AIMU can register itself and/or its models to the AIR indicating: 1) if it can be used as an AIMU and can host an AI task to use an AI model to infer knowledge; and/or 2) if it has installed any AI models for knowledge inference. During this registration with the AIR, the AIMU can also indicate its trace capability (Trace-Capability), which may be described as the amount of available computing/storage/communication resources that the AIMU can allocate for tracing AI tasks at the AIMU.

An AIMU can actively discover and download an AI model from the AIR for an installed AI task (i.e., AI agent) at the AIMU. During this process, the AIR could configure new trace instructions or update existing trace instructions for the AI task at the AIMU.

The AIR can also store the list of registered AI models, the list of registered AIMP, the list of registered AIMU to the DSS. In this case, an AIM can discover AI models, AIMPs, and/or AIMUs directly from the DSS; an AIMU can also discover and download AI models directly from the DSS.

AI Model Producer (AIMP): An AIMP can host an AI task to train and generate an AI model while supporting AI traceability, which is handled by an AI Agent for Learning (AIA4L). To achieve this objective, the AIMP can interact with other entities as follows.

Before being installed with an AI task, the AIMP can register itself with its trace capability (Trace-Capability) to an AIR, so that the AIMP can be found by an AIM (and/or an AITM), and can be assigned by the AIM with an appropriate AI task matching its Trace-Capability (and/or can be assigned by the AITM with trace instructions).

After an AI task is installed, the AIMP runs the AI task to train an AI model as specified by the AI task. The AIMP may generate AI trace records while training the model, according to the trace instructions associated with the AI task. The AIMP can store the generated AI trace records to the DSS. The AIMP can also manage (e.g., query, retrieve, aggregate, revise, remove) those AI trace records as stored on the DSS.

After the AI model is trained, the AIMP can register the AI model to the AIR, wait for an AIMU to download the AI model, and/or actively push the AI model to an AIMU. How to process the generated AI model may have been described as a part of the AI task.

When or after the AIMP runs an AI task to train an AI model, an AITM and/or an AIM can update the trace instructions associated with the AI task.

An AIMP can have an embedded AITM, which manages the traceability for the AI agent at the AIMP and/or other AI agents that use the AI model provided by the AIMP.

AI Model User (AIMU): An AIMU hosts an AI task, which uses an AI model to infer knowledge. The AIMU can support AI traceability during such a knowledge inference stage. The AI traceability functions during knowledge inference are handled by an AI Agent for Inference (AIA4I). To achieve this objective, the AIMU can interact with other entities as follows.

Before being installed with an AI task, the AIMU can register itself with its trace capability (Trace-Capability) to an AIR, so that the AIMU can be found by an AIM (and/or an AITM), and can be assigned by the AIM with an appropriate AI task matching AIMU Trace-Capability (and/or can be assigned by the AITM with trace instructions).

If the installed AI task does not come with an AI model or if the AI model needs to be updated, the AIMU can discover and download a new AI model from the AIR.

Then, the AIMU can run the AI task to infer knowledge. The AIMU may generate AI trace records during this inference stage, according to the trace instructions associated with the AI task. The AIMU can store the generated AI trace records to the DSS. The AIMU can also manage (e.g., query, retrieve, aggregate, revise, remove) those AI trace records as stored on the DSS.

When or after the AIMU runs an AI task and uses the associated AI model to infer knowledge, an AITM and/or an AIM can update the trace instructions associated with the AI task.

In addition, the AIMU can discover, download, or receive an AI model directly from an AIMP.

Distributed Storage System (DSS): A DSS stores AI trace records as sent from an AIMP and/or an AIMU. The DSS can also store repository information for an AIR (e.g., a list of registered AI models, a list of registered AIMP, a list of registered AIMU). In addition, the DSS also supports an AITM to manage AI trace records stored on the DSS. The DSS could for example be, but is not limited to, a distributed ledger system, a blockchain system, a distributed file system, or a distributed database.

According to the present principles, the address and/or the identifier of a logical entity (e.g., an AI host, an AI agent, an AI task, an AIMU, an AIMP, an AIM, an AITM, an AIR, a DSS, an API, etc.) or an information object (e.g., an AI model, a trace record, a trace instruction, an AIH record, an AI model record, a piece of training data, a piece of input data, a piece of inferred knowledge, a transaction on a ledger, a block on a ledger, a smart contract on a ledger, etc.) can also be referred to as an endpoint, which could be a Uniform Resource Identifier (URI), a Fully Qualified Domain Name (FQDN), an IP address, a port number, and/or a combination of them, etc.

Based on the example architecture in FIG. 7, the following features and corresponding procedures according to the present principles will now be described: Traceability-aware AI host registration, Traceability-aware AI task deployment, Traceability-aware AI model registration, Traceability-aware AI model discovery and registration

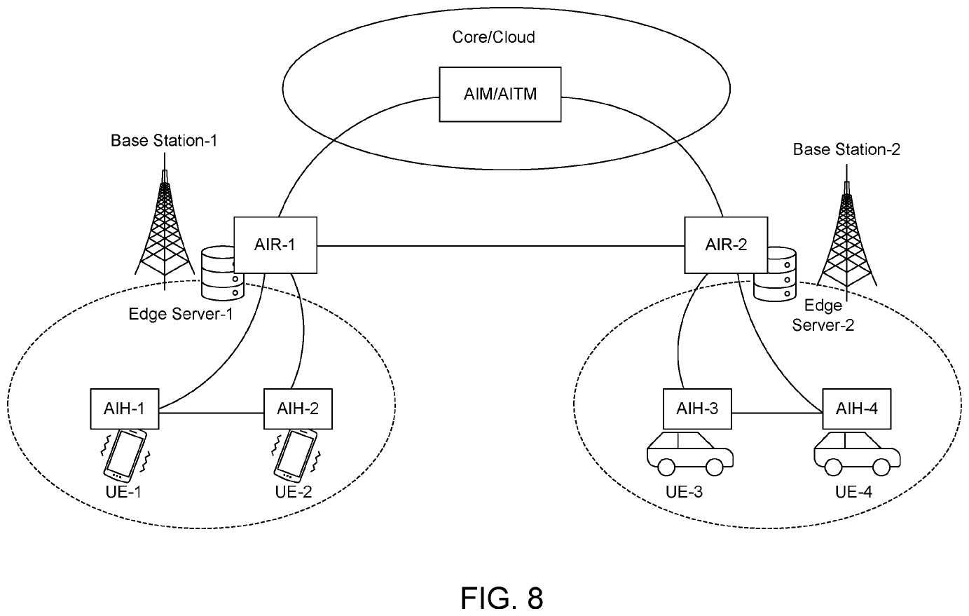

As a first example, the example architecture in FIG. 7 can be deployed in future wireless systems as illustrated in FIG. 8. In this first example, AIM and AITM are deployed together (or separately) as a single network function in the core or cloud network, AIR-1 is co-located with Edge Server-1, while AIR-2 is co-located with Edge-Server-2, and AIR-1 and AIR-2 can talk with each other directly to exchange any information maintained in both AIRs (e.g., AIH records). Further, each AIH is co-located with a UE, AIHs under Base Station-1 register to AIR-1, while AIHs under Base Station-2 register to AIR-2. AIH-1 and AIH-2 can interact with each other directly and/or aided by AIR-1/AIM/AITM, for example, to exchange AI models and/or inferred knowledge. AIH-3 and AIH-4 can interact with each other directly and/or aided by AIR-2/AIM/AITM, for example, to exchange AI models and/or inferred knowledge. AIM can talk to each AIH directly (e.g., to install an AI task to each AIH), without going through any AIR. AITM can talk to each AIH directly (e.g., to configure trace instructions to each AIH), without going through any AIR.

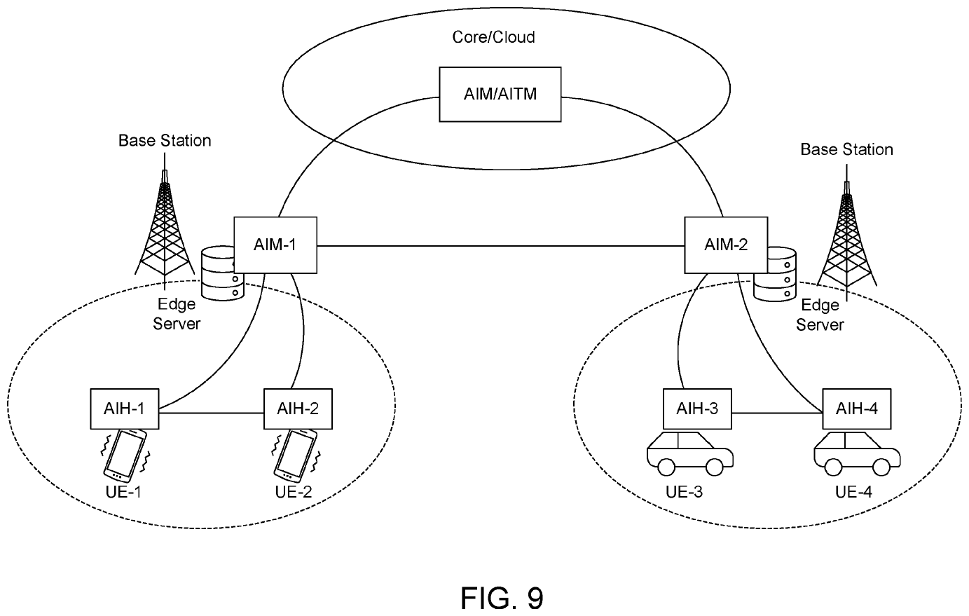

As a second example, the example architecture in FIG. 7 can be deployed in future wireless systems as illustrated in FIG. 9. In this second example, AIR and AITM are deployed together (or separately) as a single network function in the core or cloud network, AIM-1 is co-located with Edge Server-1, while AIM-2 is co-located with Edge-Server-2, and AIM-1 and AIM-2 can talk with each other directly to exchange any information maintained in both AIMs (e.g., AI tasks). Each AIH is co-located with a UE. AIHs under Base Station-1 are managed by AIM-1, while AIHs under Base Station-2 are managed by AIM-2. AIH-1 and AIH-2 can interact with each other directly and/or aided by AIM-1, for example, to exchange AI models and/or inferred knowledge. AIH-3 and AIH-4 can interact with each other directly and/or aided by AIM-2, for example, to exchange AI models and/or inferred knowledge. Each AIH can talk to AIR directly (e.g., to register AIH to AIR), without going through any AIM AITM can talk to each AIH directly (e.g., to configure trace instructions to each AIH), without going through any AIM.

### Traceability-Aware AI Host Registration

An AI Host (AIH) can be an AIMP for training an AI model or an AIMU for using an AI model for inferring knowledge. An AIH can register itself to an AIR, so that it can be discovered by an AIM before the AIM can install an AI task to the AIH. During such AIH registration, the AIH indicates its AI capability and trace capability to the AIR. The AIR can maintain a list of registered AIH records, which are exposed to the AIM and/or other entities. Note that the AIH may be pre-configured with the address of an AIR or pre-configured with an entity, from which the AIH can discover an AIR.

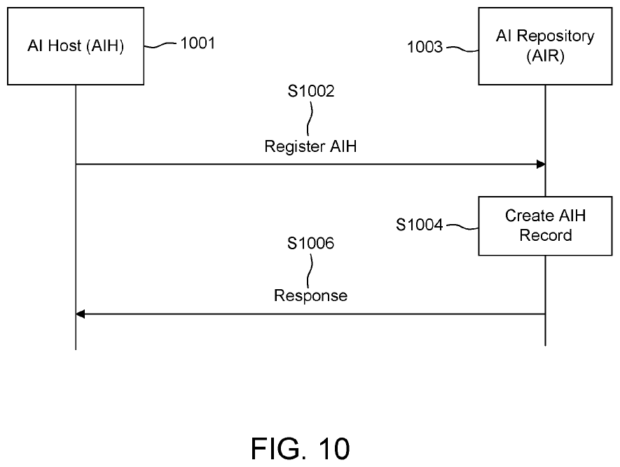

FIG. 10 illustrates an embodiment of a method of traceability-aware AIH registration.

In step S1002, the AIH 1001 sends a message to the AIR 1003 to register the AIH 1001 to the AIR 1003 and the AIR 1003 receives the message. This message can include one or more of the following parameters:

AIH-ID: An identifier or address of the AIH. If AIH is a blockchain node or user, its blockchain address (e.g., a unique identifier generated from its public key) can be used an AIH-ID.

AIH-Type: Indicates if the AIH is an AIMP, an AIMU, or both.

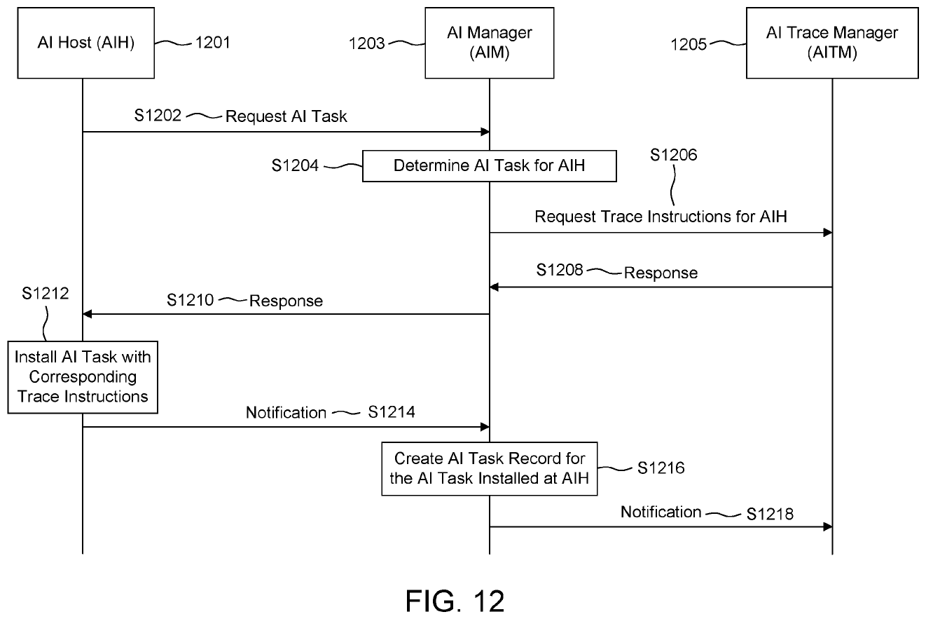

AI-Capability: The capability and affordable resources that the AIH can allocate for hosting AI tasks. This parameter could for example include one or more of 1) computing resource budget for running AI tasks, 2) storage resource budget for running AI tasks, and 3) training data properties such as the number of data samples and the number of features in a data sample. If the AIH already hosts an AI task, AI-Capability can indicate additional information including, but not limited to: 1) the unique identifier of the hosted AI task (AI-Task-ID), 2) the type of the hosted AI task as defined in step S1202 of FIG. 12 (AI-Task-Type), and 3) the API-Info of MODEL-MGMT-API.

Trace-Capability: The capability and available resources that the AIH can allocate for tracing the AI tasks. This parameter could indicate but not be limited to: 1) computing resource budget for tracing AI tasks, 2) storage resource budget for tracing AI task, 3) whether the AIH has an interface to a DSS or other external entities for storing AI trace records, 4) communication capability such as bandwidth that the AIH can use in order to send AI trace records to a DSS or other entities, 5) supported communication modes (e.g., push or pull) for other entities to obtain AI trace records, 6) whether the AIH is willing to trace “training data” if the AIH is an AIMP or trace “input data for inference” if the AIH is an AIMU. If the AIH already hosts an AI task, Trace-Capability can indicate additional information about the traceability of the hosted AI task, for example including one or more of: 1) the API-Info of TRACE-INSTRUCTION-CONFIG-API, 2) the API-Info of TRACE-RECORD-MGMT-API, 3) which part of the AI pipeline of the AI task can be traced, 4) the trace instructions that have been configured with the hosted AI task, and 5) the statistical information about the AI trace records being generated during a time period for the hosted AI task (e.g., how frequently the AI task has been generating AI trace records in the time period, the number of AI trace records being generated during the time period, where the generated AI trace records has been stored, etc.)

Training-Data-Info: If the AIH is an AIMP and has local training data, the AIH uses Training-Data-Info parameter to indicate the metadata information about training data (e.g., the type of training data, the volume of training data, the features of training data, the time the training data was generated or collected, the place from which the training data can be retrieved, etc.)

Input-Data-Info: If the AIH is an AIMU and has local input data for inferring knowledge, the AIH uses Input-Data-Info parameter to indicate the metadata information about the input data (e.g., the type of input data, the features of input data, the freshness of input data, etc.)

AIM-ID: The identifier or the address of the AIM, which controls and manages the AIR. For example, when the AIH re-registers itself with the same or a different AIR, it already knows AIM-ID and can include AIM-ID in the current registration request. In another example, the AIH may be pre-installed or provisioned with an AIM-ID.

In step S1004: If the registration request from Step 1 is approved (e.g., after the AIR 1003 verifies, authenticates, and/or authorizes the registration request as received from step S1002), the AIR may generate a new AIH-ID for the AIH. The AIR may assign an AIM and an AITM to the AIH. If the AIH is an AIMP, the AIR may recommend AIMUs from its local repository to the AIH. If the AIH is an AIMU, the AIR may recommend AIMPs from its local repository to the AIH. Then, the AIR creates an AIH record for the AIH and stores the AIH record, for example in its local repository. The AIR may publish the AIH record to a DSS or an AIM. This AIH record may for example include one or more of:
AIH-ID: The AIH-ID received in step S1002 or generated in step S1004.
AIH-Type: Received in step S1002.
AI-Capability: Received in step S1002.
Trace-Capability: Received in step S1002.
AIM-ID: Received in step S1002 or the identifier and/or the address of the AIM assigned to the AIH by the AIR.
AITM-ID: The identifier and/or the address of the AITM assigned to the AIH by the AIR.
AIMP-ID: The identifier and/or the address of AIMPs that the AIR recommends to the AIH if the AIH is an AIMU.
AIMU-ID: The identifier and/or the address of AIMUs that the AIR recommends to the AIH if the AIH is an AIMP.

The AIR can store the created AIH record to a DSS (e.g., a distributed ledger). For this purpose, the AIR creates a transaction Txt-Example, which may contain the entire created AIH record or a part of it. The AIR sends the transaction to the DSS that adds the transaction to the ledger structure (e.g., blockchain, block directed acyclic graph, blockless directed acyclic graph) after a consensus protocol. Once the transaction has been added to the ledger structure, it has a transaction sequence number (i.e., Transaction-Seq-Num) and/or an associated block sequence number (i.e., Block-Seq-Num) if the ledger uses block-bases structures. Transaction-Seq-Num and Block-Seq-Num uniquely identify the transaction Txt-Example as stored on the ledger. The DSS may return Transaction-Seq-Num and/or Block-Seq-Num to the AIR. Any entity, including the AIR, can use Transaction-Seq-Num and Block-Seq-Num to retrieve the transaction Txt-Example from the ledger. The AIR may include Transaction-Seq-Num and Block-Seq-Num in a response message to be sent to the AIH.

In step S1006, the AIR sends a response to the AIH. This response may for example include one or more of:
AIH-ID. The new AIH-ID, if one was generated in step S1004.
AIM-ID: From the AIH record generated in step S1004.
AITM-ID: From the AIH record generated in step S1004.
AIMP-ID: From the AIH record generated in step S1004.
AIMU-ID: From the AIH record generated in step S1004.
AIH-Record-ID: The identifier and/or the address of the AIH record created in step S1004.

It is noted that if the AIH has a changed AI-Capability and/or Trace-Capability, it can use the method in FIG. 10 to update the AIR with its new AI-Capability and/or Trace-Capability. Likewise, the AIH may use the method in FIG. 10 to register itself to an AIM, simply replacing the AIR with the AIM. In step S1002, the AIH can also request the AIR to remove itself from the AIR's local repository by adding a de-registration indicator.

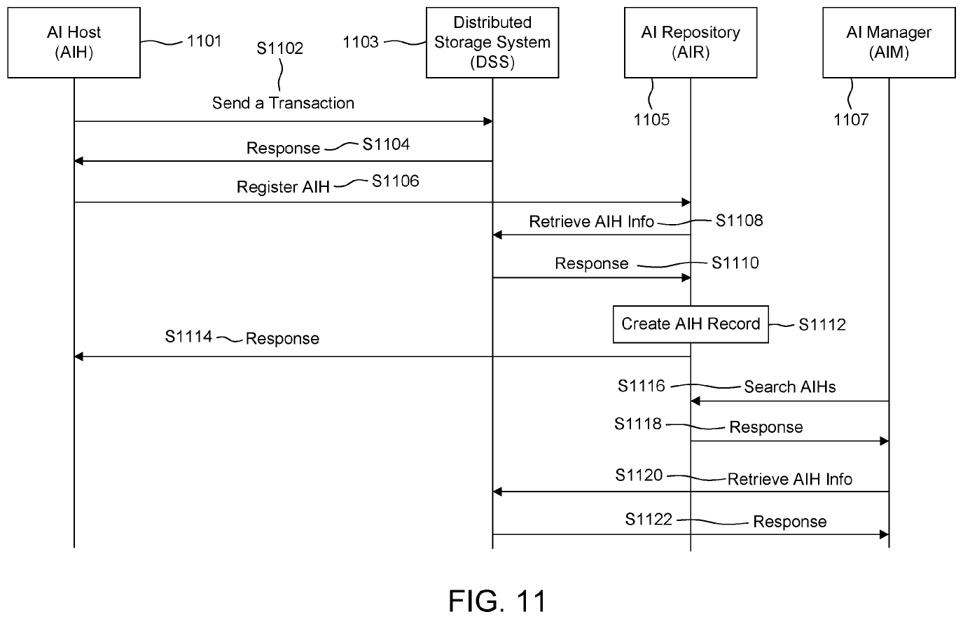

FIG. 11 illustrates an embodiment of traceability-aware AI host registration via a DSS according to the present principles. In this case, an AIH stores its registration information to a DSS (e.g., a distributed ledger) and passes the DSS's transaction and block sequence number to the AIR at registration. Such an approach may provide better immutability and reliability compared to the method illustrated in FIG. 10.

In step S1102, the AIH 1101 generates a transaction and may send the transaction to the DSS 1103. The transaction can for example include one or more of:
AIH-ID: Same as in step S1002 in FIG. 10.
AIH-Type: Same as in step S1002 in FIG. 10.
AI-Capability: Same as in step S1002 in FIG. 10.
Trace-Capability: Same as in step S1002 in FIG. 10.
Training-Data-Info: Same as in step S1002 in FIG. 10.
Input-Data-Info: Same as in step S1002 in FIG. 10.
Smart-Contract: Information indicating the willingness of and contracts for the AIH to host AI tasks. The AIH may contain multiple smart contracts in the transaction. Each smart contract may include one or more of the following:
   Desired-AI-Task: Indicates the type of desired AI Tasks. The potential types of AI tasks will be described in the section entitled Traceability-Aware AI Task Deployment.
   Requested-Payment: Indicates the payment that the AIH would like to collect if it hosts and runs a desired AI task. If the desired AI task is for training an AI model and if the AIH provides training data, the AIH may request additional or different payment.
   AI-Task-Address: Indicates the address of an AI task from which the AIH can download the AI task (e.g., software code). This is an input parameter for this Smart-Contract. For example, after this Smart-Contract is published to the DSS, an AIM can discover this Smart-Contract. If the AIM wants to trigger this Smart-Contract to deploy a target AI task to the AIH, the AIM needs to provide the address of the target AI task to this Smart-Contract via this input parameter “AI-Task-Address”.
   AI-Model-Contract-Address: Indicates the address of another smart contract for using or deploying an AI model. This is an input parameter. When this Smart-Contract is triggered by an AIM (or other entities), the AIM may provide “AI-Model-Contract-Address” as an input parameter to this AIH's Smart-Contract. As a result, the AIH may execute Smart-Contract to run an AI task to generate an AI model. In this case, the AI model can be sent automatically as an input parameter to another smart contract as denoted by “AI-Model-Contract-Address”

In case the DSS 1103 supports distributed ledger functionality such as a blockchain, the transaction will be added to the distributed ledger after certain consensus protocol or mechanism. After the transaction is added to the distributed ledger, the DSS 1103 sends, in step S1104, a response to the AIH. The response can for example include:
Transaction-Seq-Num: The sequence number of the transaction being added to the distributed ledger.
Block-Seq-Num: The sequence number of the block that the transaction was included in.

It is noted that it is possible for the DSS not to send a response to the AIH that still may obtain the Transaction-Seq-Num and Block-Seq-Num from observation of the progress of the distributed ledger.

In step S1106, the AIH sends a request to register itself to an AIR 1105. This request may for example include the following:
AIH-ID: As in step S1102.
AIH-Type: As in step S1102.
Transaction-Seq-Num: As in step S1104.
Block-Seq-Num: As in step S1104.

In step S1108, the AIR 1105 can send a request to the DSS 1103 to retrieve additional information about the AIH 1101 (e.g., other parameters included in step S1102, such as AI-Capability and Trace-Capability). This request can include Transaction-Seq-Num and Block-Seq-Num and the name of other parameters to be retrieved.

The DSS 1103 uses the identifier (e.g., Transaction-Seq-Num and Block-Seq-Num) to find the corresponding transaction created in step S1104, and extracts the requested information from this transaction. In step S1110, the DSS 1103 sends, to the AIR 1105, a response that includes the requested information.

In step S1112, which is similar to step S1004 in FIG. 10, the AIR 1105 creates an AIH record for the AIH 1101. This AIH record, which can be simpler than the one described with reference to FIG. 10, can include:
AIH-ID: As in step S1106.
Transaction-Seq-Num: As in step S1106.
Block-Seq-Num: As in step S1106.
AIM-ID: The identifier and/or the address of the AIM that the AIR assigns to the AIH.
AITM-ID: The identifier and/or the address of the AITM that the AIR assigns to the AIH.
AIMP-ID: The identifier and/or the address of AIMPs that the AIR recommends to the AIH if the AIH is an AIMU. For this purpose, the AIR may contact the DSS to retrieve detailed information about other AIMPs.
AIMU-ID: The identifier and/or the address of AIMUs that the AIR recommends to the AIH if the AIH is an AIMP. For this purpose, the AIR may contact the DSS to retrieve detailed information about other AIMUs.

In step S1114, the AIR 1105 sends a response to the AIH 1101. This response may include:
AIM-ID: As in step S1112.
AITM-ID: As in step S1112.
AIMP-ID: As in step S1112.
AIMU-ID: As in step S1112.
AIH-Record-ID: The identifier and/or the address of the AIH record created in step S1112.

In step S1116, an AIM 1107 (or another AIH) sends a request to the AIR 1105 to discover one or multiple target AIHs 1101. The request can include discovery filters (e.g., wildcards of AIH-Type and/or AIH-ID of target AIHs).

The AIR 1105 uses the discovery filter to look up AIH records to find target AIHs. For each discovered target AIH, the AIR may include the following information in a response that it, in step S1118, sends to the AIM 1107 (or the other AIH):
Transaction-Seq-Num: The sequence number of the transaction containing the detailed information about the target AIH.
Block-Seq-Num: The sequence number of the block contain the transaction about the target AIH.
AIH-ID: The identifier or the address of the target AIH.
AIH-Type: The type of the target AIH.

As in other embodiments, the Transaction-Seq-Num and Block-Seq-Num are examples of information that can constitute a ledger identifier.

In step S1120, which is similar to step S1108, the AIM 1107 (or another AIH) sends a request to the DSS 1103 to retrieve additional information about each discovered target AIH.

In step S1122, which is similar to step S1110, the DSS 1103, having retrieved requested information, sends a response including additional information about the discovered target AIH to the AIM 1107 (or another AIH).

### Traceability-Aware AI Task Deployment

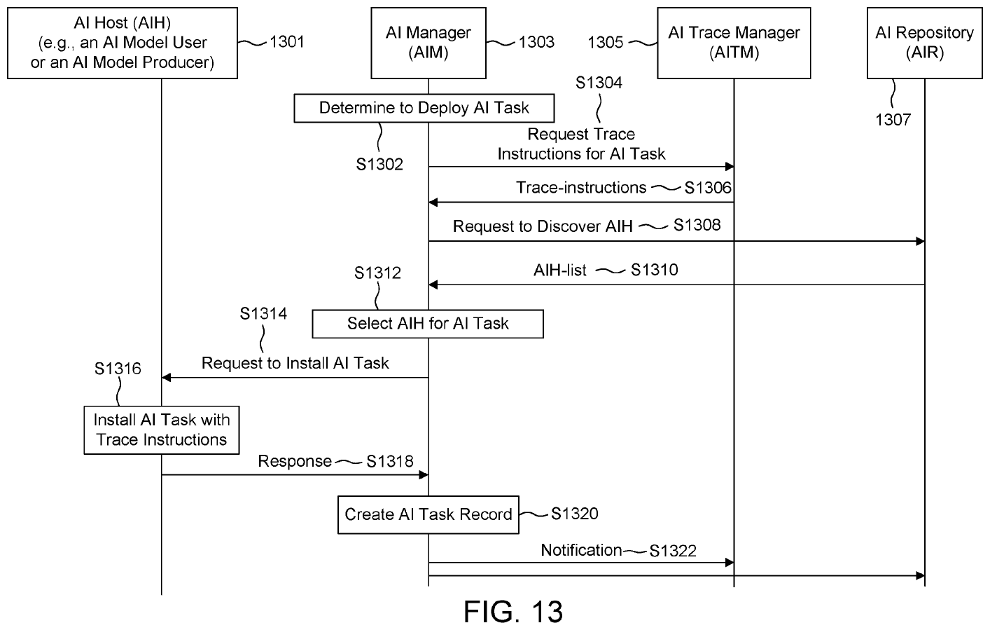

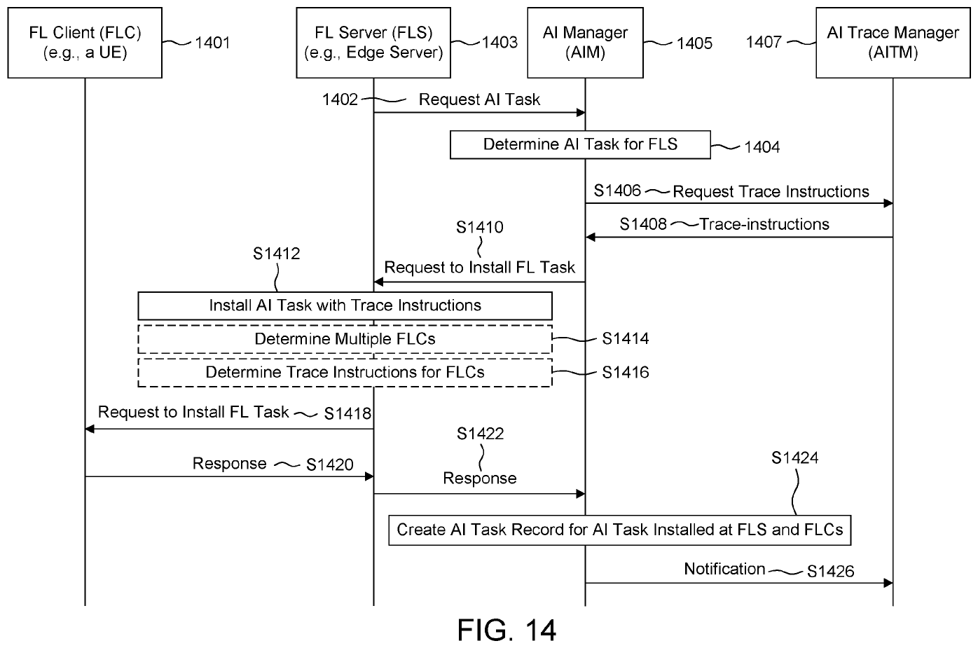

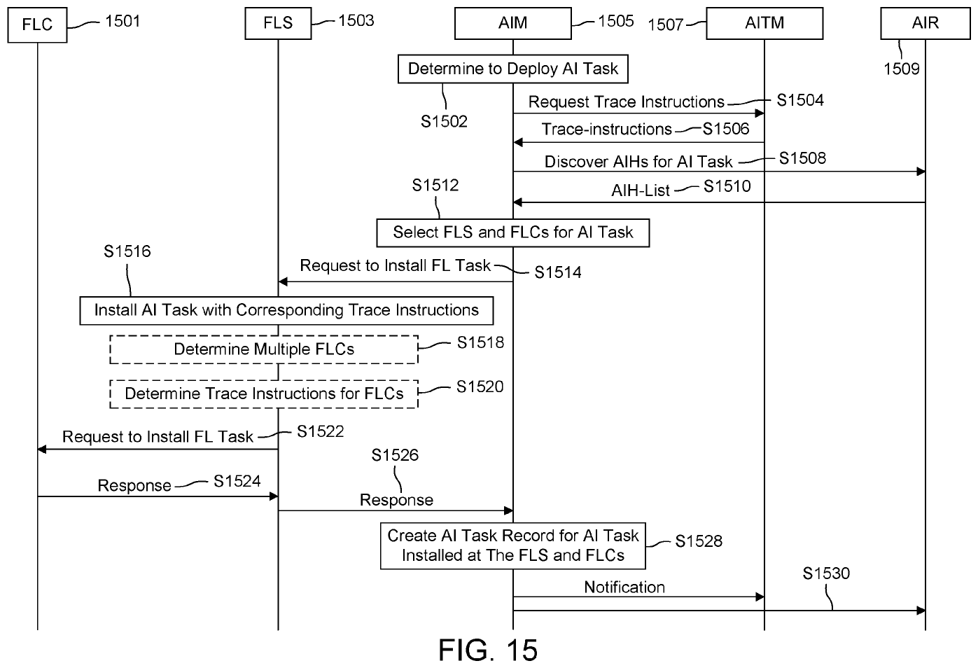

Four embodiments of Traceability-aware AI task deployment will be described. FIG. 12 illustrates AIH-Initiated Traceability-Aware AI Task Deployment. FIG. 13 illustrates AIM-Initiated Traceability-Aware AI Task Deployment. FIG. 14 illustrates AIH-Initiated Traceability-Aware FL Task Deployment. FIG. 15 illustrates AIM-Initiated Traceability-Aware FL Task Deployment.

### AIH-Initiated Traceability-Aware AI Task Deployment

An AI Host (AIH) (an AIMP or an AIMU) actively requests an AI task from an AIM. The AIH first presents the requested AI task, its AI capability, and its trace capability to the AIM. Then, the AIM approves and determines an appropriate AI task according to the AI capability of the AIH. The AIM also obtains trace instructions from an AITM for the AI task, according to the trace capability of the AIH. Those trace instructions are simultaneously sent to the AIH during the deployment of the AI task to the AIH. The AIM creates an AI task record for each AI task being deployed to the AIH. The AIM may store the AI task record locally and/or to other entities (e.g., a DSS). It is assumed that: 1) The AIH has been provisioned with the AIM and knows the address of the AIM; and 2) The AIM has been provisioned with the AITM and knows the address of the AITM. Note that the AIM and AITM could be implemented together as one physical or logical node.

FIG. 12 illustrates a method of AIH-Initiated Traceability-Aware AI Task Deployment according to an embodiment.

In step S1202, the AIH 1201, for example an AI model user or an AI model producer, sends a request message to an AIM 1203 to request an AI task to be deployed to the AIH 1201. This message may include one or more or the following:
AI-Task-ID: A unique identifier or address of the AI task to be deployed. If this parameter is included in the message, further parameters may be omitted.
AIH-ID: The identifier or the address of the AIH 1101.
AI-Task-Type: The type of the AI task that the AIH 1101 requests. AI-Task-Type could indicate if the requested task is for training a model, inferring knowledge, or both. AI-Task-Type could also indicate if the requested AI task is a DI, task, a FL task, RI, task, or other kinds. AI-Task-Type could also indicate the purpose of the requested AI task (e.g., regression, classification, clustering, etc.). AI-Task-Type could also indicate the application category of the request AI task (e.g., natural language processing, text processing, image processing, video processing, etc.).
AI-Task-Size-Threshold: The AIH 1101 requires that the size of the AI task it requests should be less than AI-Task-Size-Threshold. The size of an AI task usually depends on the size of the software code and the size any related data.
AI-Capability: The capability and affordable resources that the AIH 1101 can allocate for hosting AI tasks. This parameter could for example indicate, but is not limited to, 1) computing resource budget for running AI tasks, 2) storage resource budget for running AI tasks and 3) training data properties such as the number of data samples and the number of features in a data sample.
Trace-Capability: The capability and available resources that the AIH 1101 can allocate for tracing the AI tasks. This parameter could for example indicate, but is not limited to, 1) computing resource budget for tracing AI tasks, 2) storage resource budget for tracing AI task, 3) whether the AIH 1101 has an interface to a DSS or other external entities for storing AI trace records, 4) communication capability such as bandwidth that the AIH 1101 can use in order to send AI trace records to a DSS or other entities, 5) supported communication modes (e.g., push or pull) for other entities to obtain AI trace records, 6) whether the AIH 1101 is willing to trace “training data” if the AIH 1101 is an AIMP or trace “input data for inference” if the AIH 1101 is an AIMU.
AITM-ID: The identifier or the address of the AITM 1205. This parameter, which is optional, can be used by the AIH 1101 to specify a particular AITM, if it is known.

It is noted that the AI task to be deployed can be uniquely identified by AI-Task-ID. Alternatively, the AIM 1203 can use a combination of multiple other parameters in step S1202 (e.g., AI-Task-Type and AI-Task-Size-Threshold) to identify one or multiple AI tasks that it can select for the AIH.

In step S1204, the AIM 1203 selects (i.e., determines) an AI task for the AIH 1101 based on parameters received in step S1202, such as AI-Task-Type and AI-Capability. The AIM 1203 generates a unique identifier for the selected AI task (AI-Task-ID), which could be based on AIH-ID, AI-Task-Type, other parameters from the request in step S1202, and/or other local information at the AIM 1203. Note that each AI task stored at the AIM 1203 may have an associated AITM 1205, through which the AIM 1203 can request corresponding trace instructions.

In step S1206, the AIM 1203 sends a message to the AITM 1205 to request trace instructions for the selected AI task. This message may include AIH-ID, Trace-Capability, AI-Task-Type, all as in step S1202.

The AITM 1205 receives the message and determines trace instructions for the AIH 1201 to trace the requested AI task. The determination can be based on parameters such as AIH-ID, Trace-Capability and AI-Task-Type as received in the message in step S1206. The AITM 1205 sends a response message to the AIM 1203. The response message contains the determined trace instructions (i.e., Trace-Instructions) for the AIH 1201. Trace-Instructions may contain one or multiple trace instructions. Each trace instruction (TI (i)) may for example include the following parameters:
Trace-Instruction-ID: A (statistically or probably) unique identifier of TI (i). As an example, the hash of TI (i) content with additional information can be used as the unique identifier.
Trace-Scope: The trace scope for the selected AI task. The trace scope could be one or more of: 1) for all training rounds or for selected training rounds, 2) for all iterations of knowledge inference or for selected iterations of knowledge inference, 3) the training data used in a training round, 4) the correlation between the training data and corresponding model update (e.g., gradient of a DNN model) in a training round, 5) the partial or full model update generated in a training round, 6) the trend of model accuracy during the training, 7) the model convergence rate during the training, 8) the trained model for testing and validating, 9) the failures during test and validation stage, 10) the trained final model, 11) other statistics about the training stage (e.g., the distribution of used training data, the weight distribution of the final model if it is a DNN model, etc.), 12) the model used for knowledge inference, 13) the input data for inference, 14) the inferred knowledge, 15) the correlation between the input data for inference and the inferred knowledge, 16) the discrepancy between the inferred knowledge and the action that an AIMU takes that may or may not be based on the inferred knowledge, and 17) other statistics about the knowledge inference (e.g., the distribution of used input data for inference, the distribution of inferred knowledge, the time/location information about when/where knowledge inference is triggered, etc.).
Trace-Record-Format: Defines the format (e.g., Concise Binary Object Representation (CBOR), JavaScript Object Notation (JSON)) and metadata for generated AI trace records. The metadata of a trace record (TR (j)) may contain but not limited to the following parameters:
   Trace-Record-Creator: The identifier of an AIH that creates TR (j).
   Trace-Record-Creation-Time: The time when TR (j) is created.
   Trace-Record-Creation-Location: The location of the AIH when it creates TR (j). This parameter can be useful to capture instantaneous location if the AIH is not stationary.
   Trace-Record-Identifier: The identifier of TR (j) such as an address or a Uniform Resource Identifier (URI), through which TR (j) can be accessed. This parameter may be blank if TR (j) is never stored locally at the AIH that creates TR (j).
   Trace-Record-Content-Type: The type of the content contained in TR (j), which could be about one or a combination of the following types: training data, AI model updates, final AI model, input data for inference, inferred knowledge, model training statistics, knowledge inference statistics, etc.
Trace-Record-Creation-Condition: Describes the conditions under which a new trace record will be created by an AIH. The conditions could be based on one or multiple following parameters, but not limited to:
   Trace-Record-Creation-Time-Windows: time window(s), within which an AIH creates trace records according to the following parameters.
   Trace-Record-Creation-Frequency: frequency for creating trace records periodically.
   AI-Model-Training-Accuracy-Range: a new trace record is created when the instantaneous accuracy of the AI model (i.e., calculated based on the loss function) under training is within the range as defined by AI-Model-Training-Accuracy-Range.
   AI-Model-Test-Accuracy-Range: a new trace record is created when the tested accuracy of the AI model under testing data is within the range as defined by AI-Model-Test-Accuracy-Range.
   AI-Model-Test-Failure-Threshold, a new trace record is generated when the number of failures occurring in the test stage exceeds the threshold as defined by AI-Model-Test-Failure-Threshold.
   AI-Model-Attack-Detection: A new trace record is generated when a backdoor or other data poison attacks are detected by the AIH based on attack detection algorithms.
Trace-Record-Forwarding-Address: Indicates the location and/or the address for storing trace records to be created. This parameter may be empty or just indicate “LOCAL”. As a result, an AIH using this trace instruction will simply store any created trace records locally. This parameter may include an address pointing to an external entity (e.g., a DSS), to which the AIH using this trace instruction will forward any created trace records.
Trace-Record-Forwarding-Condition: It describes the conditions under which an AIH shall forward the created trace records to an external entity as indicated by Trace-Record-Storage-Address. The conditions could be based on one or more of:
   Trace-Record-Maximum-Buffer-Time: Indicates the maximum time a trace record can be buffered locally at the AIH before the AIH forwards it to the external entity.
   Trace-Record-Forwarding-Frequency: Indicates how fast the AIH shall forward the generated trace records. For example, the AIH may forward M trace records together to the external entity each time when M new trace records are created. M is contained in Trace-Record-Forwarding-Frequency.
Trace-Record-Forwarding-Metadata: Indicates metadata required by an external entity (e.g., a DSS), when an AIH forwards trace records to it. For example, when the external entity is a blockchain or distributed ledger system, Trace-Record-Forwarding-Metadata can indicate the corresponding blockchain transaction format. The AIH can encapsulate M trace records in one or multiple blockchain transactions according to the transaction format, and send these blockchain transactions to the external blockchain system.
Trace-Record-Forwarding-Credentials: Indicates credentials, which an AIH shall use in order to forward trace records to an external entity as denoted by Trace-Record-Storage-Address. The credentials could be a token or a certificate to access the external entity. When the AIH forwards trace records to the external entity, it presents the credentials to the external entity that can authenticate and authorize the AIH based on the credentials. If the external entity is a blockchain or distributed ledger system, Trace-Record-Forwarding-Credentials may contain a blockchain account (e.g., derived from the public key of the AIH and/or AITM) that the AITM assigns to the AIH.

Trace-Scope and Trace-Record-Creation-Condition together determine when an AI trace record shall be generated, which will following the format as defined by Trace-Record-Format.

It is noted that the response in step S1208 may simply include a list of trace instruction identifiers instead of the full content of each trace instructions, for example if the full content is too large. As a result, the AIM can use separate steps to present one or multiple trace instruction identifiers to the AITM to retrieve the full content of corresponding trace instructions.

It is also noted that steps S1206 and S1208 may be omitted if the AIM 1203 can determine trace instructions for the AIH 1201, for example, leveraging previously provisioned or buffered trace instructions as received from the AITM 1205.

In step S1210, the AIM 1203 sends a response to the AIH 1201 to install/deploy the selected AI task to the AIH. This response can include:
AI-Task-Content: software code of the selected AI task. If this is included, AI-Task-Content-Address (see below) may not be needed; if this is not included, AI-Task-Content-Address can be required instead.
AI-Task-Content-Address: address from which the software code of the selected AI task can be downloaded. If this is included, the AIH 1201 can perform additional actions to download the AI task's software code before it can physically install the AI task.
AI-Task-ID: unique identifier of the selected AI task.
Trace-Instructions: as received in the response in step S1208 (or obtained elsewhere).
AIR-ID: identifier of an AIR, from which the AIH 1201 can discover an updated AI model.
AI-Model-ID: identifier of an existing AI model, which the AIM 1203 wants the AIH 1201 to retrieve and install with the AI task. This may not be needed when the AI task is for learning. If AI-Model-ID is contained in the message, AI-Model-Content (see below) can be omitted.
AI-Model-Content: content of an AI model. This may not be needed if the AI task is for learning. Even if the AI task is for inferring knowledge, this parameter could be optional since the AIM 1203 can use AIR-ID or AI-Model-ID to instruct the AIH 1201 to discoverer retrieve an AI model from the AIR. When AI-Model-Content is contained in this message, AI-Model-ID is not needed. If the AI task is a semi-supervised learning task, AI-Model-Content or AI-Model-ID is needed.

If the task to be installed is an AI model training task, the message may additionally include:
Training-Data-Source: the location (e.g., a URI, a FQDN, etc.) where the AIH 1201 should retrieve or download the training data. If the AIH 1201 already has the training data as it may have indicated during AIH registration, it does not need to download the training data; in this case, this is optional.
Model-Handling: how the trained AI model shall be handled. This could indicate different possibilities. As a first example, once the AIH completes the training process and generate an AI model, the AIH shall return the AI model to the AIM. Alternatively, the AIH shall inform the AIM of the availability of the AI model and the AIM can retrieve the AI model from the AIH. As a second example, the AIH shall register the trained AI model to an AIR. In this case, this parameter may also include the address of the AIR.

If the task to be installed is a knowledge inference task, the message may additionally include:
Input-Data-Source: the place (e.g., a Uniform Resource Locator (URL)) where the AIH can retrieve or download the input data and derive the knowledge from the input data. If the AIH already has the input data as it may have indicated during AIH registration, it does not need to download the input data; in this case, this is optional.
Knowledge-Handling: how the inferred knowledge shall be handled. This could indicate different possibilities. As a first example, once the AIH completes the inference process and generates knowledge, the AIH may return the knowledge to the AIM. Alternatively, the AIH may inform the AIM of the availability of the knowledge and the AIM can retrieve the knowledge from the AIH. Also, the AIH can send the knowledge directly to knowledge consumers (e.g., an AIMP for using the knowledge to train its own model). As a second example, the AIH can maintain the knowledge locally for itself.

The response in step S1210 may also solicit a notification (i.e., in step S1214) to be sent from the AIH 1201 to the AIM 1203 after the AIH has installed the AI task in step S1212.

In step S1212, the AIH 1201 installs the AI task locally. The AIH 1201 can also configure the received trace instructions (i.e., Trace-Instructions) with the installed AI task, so that the AI task, when it starts running, generates AI trace records according to the trace instructions. If AI-Model-Content is included in the response, the AIH will install the corresponding AI-Model-Content with the AI task. If AIR-ID or AI-Model-ID are included in the message, the AIH may discover or retrieve an AI model from an AIR, that it then installs with the AI task. The AIH can generate one or multiple addresses through which the installed AI task can be accessed, referred to as AI-Task-Address. AI-Task-Address may include:
The API-Info of TRACE-CONFIG-API of the installed AI task.
The API-Info of TRACE-MGMT-API of the installed AI task.
The API-Info of MODEL-MGMT-API of the installed AI task.

In step S1214, the AIH 1201 sends a notification to the AIM 1203 indicating the successful installation (or unsuccessful installation) of the AI task as requested in step S1210 The AIH 1201 may optionally store this response to a DSS or an AIR. This notification may for example include:
AIH-ID: As in step S1202.
AI-Task-Address: Generated in step S1212.

The AIH 1201 may also create a transaction containing the same notification and send the transaction to a DSS (e.g., a distributed ledger). The transaction may also contain AI-Task-ID, AI-Task-Content, and AI-Task-Type. After the transaction is added to the distributed ledger, the AIH will know the corresponding Transaction-Seq-Num and Block-Seq-Num for the added transaction. Then, the AIH can send Transaction-Seq-Num and Block-Seq-Num to the AIM.

In step S1216, having received the notification, the AIM 1203 creates an AI task record for the installed AI task at the AIH 1201. The AIM 1203 may publish the AI task record to a DSS or an AIR. For example, the AIM 1203 may create a transaction containing the AI task record and sends the transaction to the DSS (e.g., a distributed ledger). The AI task record may include:
AIH-ID: As in step S1214.
AI-Task-ID: As in step S1210.
AI-Task-Address: As in step S1214.
AI-Task-Type: As in step S1202.
Trace-Instructions: As in step S1210.

In step S1218, the AIM 1203 sends a notification to the AITM 1205. This notification may include the AI task record generated in step S1216. The AIM 1203 may send the same notification to an AIR and/or a DSS.

### AIM-Initiated Traceability-Aware AI Task Deployment

To deploy an AI task, an AIM determines the AI task and requests trace instructions for the AI task from an AITM. According to the trace instructions and the determined AI task, the AIM discovers one or multiple appropriate AIHs (AIMPs or AIMUs) from the AIR. Note that the AIR maintains trace capability of each registered AIH. Generally speaking, the AIM compares trace capability of each registered AIH against the trace instructions from the AITM to determine the appropriate AIHs that can meet the trace instructions. Then, the AIM selects an AIH from the list of appropriate AIHs received from the AIR and installs the determined AI task with the trace instructions to the selected AIH.

FIG. 13 illustrates a method of AIM-initiated traceability-aware AI task deployment according to an embodiment of the present principles.

In step S1302, the AIM 1303 determines to deploy an AI task. It is noted that the AIM 1303 maintains a list of AI tasks.

The AIM 1303 may search one or more AIR from a DSS (e.g., a distributed ledger), especially if AIH information has been published to the distributed ledger during AIH registration process. The search may take place before or after step S1302. In case the AIM searches an AIR, steps S1304-S1310 may be omitted.

In step S1304, the AIM 1303 sends a request message to the AITM 1305 to request trace instructions for the AI task. This message can include:
AI-Task-Type: The type of the AI task that the AIH requests. AI-Task-Type can indicate if the requested task is for training a model, inferring knowledge, or both. AI-Task-Type can also indicate if the requested AI task is a DL task, an FL task, RL task, or other kinds. AI-Task-Type can also indicate the purpose of the requested AI task (e.g., regression, classification, clustering, etc.). AI-Task-Type can also indicate the application category of the request AI task (e.g., natural language processing, text processing, image processing, video processing, etc.).
AI-Task-ID: An optional unique identifier of the selected AI task. It can for example be included in the request message if the AITM 1305 can understand it and use it to determine the corresponding trace instructions.

The AITM 1305 uses AI-Task-Type and/or AI-Task-ID to determine the trace instructions for the AI task. In step S1306, the AITM 1305 sends to the AIM a response including Trace-Instructions that indicate how and which type of information related to the AI task should be traced and recorded. This is similar to Trace-Instructions as described in step S1208 of FIG. 12.

In step S1308, the AIM 1303 sends a message to the AIR 1307 to discover one (or multiple) AIH 1301 that the AI task will be deployed to. This message may include:
AI-Task-ID: Same as in step S1304.
AI-Task-Type: Same as in step S1304.
Trace-Instructions: Same as in step S1306.
Other-Discovery-Criteria: Indicates other criteria used to discover AIHs, such as, for example, the reputation threshold for selecting AIHs.

Upon reception of the message, the AIR 1307 searches a (e.g., its own local) repository to find a list of appropriate AIHs, which match AI-Task-ID, AI-Task-Type, Trace-Instructions, and/or Other-Discovery-Criteria. In step S1310, the AIR 1307 sends a response to the AIM 1303. This response may include AIH-List, a list of appropriate AIHs being discovered.

If the AIH information has been published to a DSS (e.g., a distributed ledger) during AIH registration process, the AIR 1307 may search AIH information (e.g., AI-Capability, Trace-Capability) from the DSS in order to find the appropriate AIHs.

In step S1312, the AIM 1303 may select one (or multiple) AIH from the list of AIHs received from the AIR 1307. The AIM 1303 may simply use Trace-Instructions received in step S1306 as Trace-Instructions to be contained in step S1314. Alternatively, the AIM 1303 may modify trace instructions as received in step S1306.

In step S1314, the AIM 1303 sends a message to request installation of the AI task to the selected AIH 1301. This message may include:
AI-Task-ID: Same as in step S1304.
AI-Task-Type: Same as in step S1304.
AI-Task-Content: Software code of the AI task.
AI-Task-ID: A (at least probably) unique identifier of the AI task.
Trace-Instructions: From step S1312.

In case AI-Task-Type indicates an AI model training task, the message in step S1314 may include:
Training-Data-Source: the location (e.g., a Uniform Resource Locator (URL)) from where the AIH should retrieve or download the training data.
Model-Handling: how the trained AI model shall be handled. This could indicate different possibilities. As a first example, once the AIH 1301 completes the training process and generate an AI model, it shall return the AI model to the AIM 1303. Alternatively, the AIH 1301 shall inform the AIM 1303 of the availability of the AI model and the AIM 1303 can retrieve the AI model from the AIH 1301. As a second example, the AIH 1301 can register the trained AI model to an AIR 1307 by itself. In this case, Model-Handling may also include the address of the AIR.

In case AI-Task-Type indicates a knowledge inference task, the message in step S1314 may additionally include:
Input-Data-Source: the location (e.g., a Uniform Resource Locator (URL)) from where the AIH should retrieve or download the input data and derive the knowledge from the input data.
Knowledge-Handling: how the inferred knowledge shall be handled. This could indicate different possibilities. As a first example, once the AIH 1301 completes the inference process and generate knowledge, it shall return the knowledge to the AIM 1303. Alternatively, the AIH 1301 shall inform the AIM 1303 of the availability of the knowledge and the AIM 1303 can retrieve the knowledge from the AIH 1301. Also, the AIH 1301 can send the knowledge directly to knowledge consumers (e.g., an AIMP for using the knowledge to train its own model). As a second example, the AIH 1301 can maintain the knowledge locally for itself.

In step S1316, the AIH 1301 installs the AI task with the trace instructions. This step can be the same as step S1212 in FIG. 12.

In step S1318, the AIH 1301 sends a response to the AIM 1303 to indicate success (or not) of the installation. This step can be the same as step S1214 in FIG. 12.

The AIH 1301 may also (or alternatively) create a transaction containing the response and send the transaction to a DSS (e.g., a distributed ledger). The transaction may also contain AI-Task-ID, AI-Task-Content, and AI-Task-Type. After the transaction is added to the distributed ledger, the AIH 1301 knows the corresponding ledger identifier. Then, the AIH 1301 can send ledger identifier to the AIM 1305.

In step S1320, the AIM 1303 creates an AI task record for the AI task installed at the AIH 1301. This step can be the same as step S1216 in FIG. 12.

In step S1322, the AIM 1303 can send a notification to the AITM 1307. This step can be the same as step S1218 in FIG. 12. The AIM 1303 may send the notification to the AIR 1307 and/or a DSS. For example, the AIM 1303 may create a transaction containing this notification and sends the transaction to the DSS (e.g., a distributed ledger).

### AIH-Initiated Traceability-Aware FL Task Deployment

FIG. 14 illustrates a method of AIH-initiated traceability-aware FL task deployment, according to an embodiment of the present principles. The method is similar to that illustrated in FIG. 12 but extends the general AI task to a FL task.

In step 1402, an FLS 1403 sends a message to an AIM 1405 to request an AI task (i.e., an FL task in this case). This is similar to step S1202 in FIG. 12. The AIH-ID contained in this message is the identifier of the FLS. The FLS 1403 may indicate in the message if it requires the AIM 1405 to discover FLCs 1401 and how many FLCs are needed. Even if the FLS 1403 has the list of FLCs ready, the FLS 1403 can request the AIM 1405 to reselect FLCs 1401. The FLS 1403 can also send the list of its FLCs (e.g., their unique identifiers) to the AIM 1405 that may authenticate those FLCs based on the information contained in this message and/or additional information the AIM 1405 can retrieve from an AIR about each FLC.

In step S1404, the AIM 1405 determines an AI task (i.e., an FL task) for the FLS 1403. This is similar to step S1204 in FIG. 12. In addition, the AIM 1405 may determine FLCs for the determined AI task, for instance, to discover appropriate AIHs from an AIR and assign the discovered AIHs as FLCs. The AIM 1405 may also select the FL aggregation algorithm (e.g., synchronous or asynchronous) for the determined FL task.

In step S1406, similar to step S1206 in FIG. 12, the AIM 1405 sends a message to an AITM 1407 to request trace instructions. The AIH-ID contained in this message contains the identifier of the FLS 1403. AIH-ID may also contain the identifier of FLCs determined in step S1404.

In step S1408, the AITM 1407 sends a response to the AIM 1405. This is similar to step S1208 in FIG. 12. Trace-Instructions included in this response could be for the FLS 1403 only, and optionally for each FLC if any FLCs are indicated in step S1406.

In step S1410, the AIM 1405 sends a request to the FLS to install the determined task. This is similar to step S1210 in FIG. 12. The request may include FL-Parameters, i.e., the list of FLCs (e.g., their identifiers) determined in step S1404, and/or the selected FL aggregation algorithm in step S1404.

In step S1412, the FLS 1403 installs the AI task (i.e., the FL task). This is similar to step S1212 in FIG. 12. After successful installing the AI task, the FLS may, similar to step S1214 in FIG. 12, send a response to the AIM to indicate success (or failure).

In step S1414, the FLS 1403 may determine FLCs for the AI task. Even in case a list of FLCs is indicated in step S1410, the FLS 1403 may select none or some from the list or select other FLCs.

In step S1416, the FLS 1403 determines trace instructions for each FLC, based on the trace instructions received in step S1410.

In step S1418, the FLS 1403 sends a request to an FLC 1401 to install the AI task. This step is similar to step S1410, a difference being that this request may include FLS-ID, the identifier of the FLS.

The FLC 1401 installs the AI task, similar to step S1412, and, in step S1420, sends a response to the FLS 1403. This response may include FLC-ID, i.e., the identifier of the FLC, and AI-Task-Address, similar to AI-Task-Address in step S1214 in FIG. 12.

In step S1422, which is similar to step S1214 in FIG. 12, the FLS 1403 sends a response to the AIM 1405. The FLS 1403 may wait for receiving responses from all FLCs for which it has requested to install a FL task, aggregate the responses and generate send the aggregated response to the AIM 1405. Alternatively, the FLS 1403 may send individual responses regarding the FLC 1401 to the AIM 1405, for example upon reception of the response in step S1420. The response may include AIH-ID, i.e., the identifier of the FLS 1403 and each FLC 1401 concerned by the response, and AI-Task-Address indicating the address for the AI task installed at the FLS 1403 and the AI task installed at each FLC 1401.

In step S1424, similar to step S1214 in FIG. 12, the AIM 1405 creates an AI task record for the AI tasks installed at the FLS 1403 and all FLCs 1401. Alternatively, the AIM 1405 creates one AI task record for the AI task installed at the FLS 1403, and one AI task record for the AI task installed at each FLC 1401.

In step S1426, the AIM 1405 sends a notification to the AITM 1407. This notification may include the AI task records created in step S1424. The notification may also or alternatively be sent to an AIR and/or a DSS.

### AIM-Initiated Traceability-Aware FL Task Deployment

FIG. 15 illustrates a method of AIM-initiated traceability-aware FL task deployment according to an embodiment of the present principles. The method is similar to the one illustrated in FIG. 13, but the deployed AI task is an FL task.

In step S1502, similar to step S1302 in FIG. 13, an AIM 1305 determines to deploy an AI task (i.e., an FL task in this case).

In step S1504, similar to step S1304 in FIG. 13, the AIM 1305 sends a message to an AITM 1307 to request trace instructions for the determined AI task.

In step S1506, similar to step S1306 in FIG. 13, the AITM 1307 sends a response containing trace instructions to the AIM 1305.

In step S1508, similar to step S1308 in FIG. 13, the AIM 1505 sends a message to an AIR 1509 to discover AIHs for the AI task. Since the AI task is an FL task, the AIM 1505 may request to discover both a FLS 1503 and FLCs 1501.

The AIR 1509 searches a repository, for example its local repository, to find multiple FLS and multiple FLCs if the AIM requests for FLCs as well in step S1508. In step S1510, the AIR 1509 sends to the AIM 1505 a response including an AIH-List that indicates the identifiers of multiple FLS and identifiers of all FLCs.

In step S1512, the AIM 1505 selects a FLS 1503 and multiple FLCs 1501 for the AI task. Alternatively, the AIM 1505 may select a FLS 1503 only and let the FLS 1503 select FLCs 1501 in step S1518.

In step S1514, similar to step S1410 in FIG. 14, the AIM 1505 sends to the FLS 1501 (or, as the case may be, FLSs) to install the FL task at the FLS 1503.

The FLS 1503 installs the FL task. In step S1516, similar to step S1412 in FIG. 14, the FLS 1503 may send a response to the AIM 1505 indicating the successful installation (or failure) of the FL task at the FLS 1505.

In step S1518, similar to step S1414 in FIG. 14, the FLS 1503 may reselect FLCs.

In step S1520, similar to step S1416 in FIG. 14, the FLS 1503 determines trace instructions for each FLC.

In step S1522, similar to step S1418 in FIG. 14, the FLS 1503 sends a message to a FLC 1501 to request installation of the FL task.

The FLC 1501 installs the FL task and, in step S1524, similar to step S1420 in FIG. 14, sends a response to the FLS 1503.

In step S1526, similar to step S1422 in FIG. 14, the FLS 1503 sends a response to the AIM 1505.

In step S1528, similar to step S1424 in FIG. 14, the AIM 1505 creates one or multiple AI task records.

In step S1530, similar to step S1426 in FIG. 14, the AIM 1505 sends the AI task records to the AITM 1507 and the AIR 1509 (and possibly also to a DSS).

### Traceability-Aware AI Model Registration

An AIMP can register its produced (i.e., trained) AI models to an AIR, which can be discovered by and shared to AIMUs. Alternatively, when an AIMP produces an AI model, it may send the AI model including its metadata to an AIM, which has installed the AI task to the AIMP for training the AI model and, as a result, the AIM registers the AI model to the AIR.

When the AIMP (or the AIM) registers an AI model, it may have traceability requirements on the AI model. As a result, the AIMP (or the AIM) configures the required trace instructions with the AI model to be registered.

It takes time for the AIMP to train an AI model. But the AIMP may want its AI models to be discoverable by AIMUs before it is fully trained. In other words, the AI model being registered by the AIMP could be fully trained or partially trained. When the AIMP registers a partially trained AI model, it can be regarded as a model pre-registration or model pre-announcement.

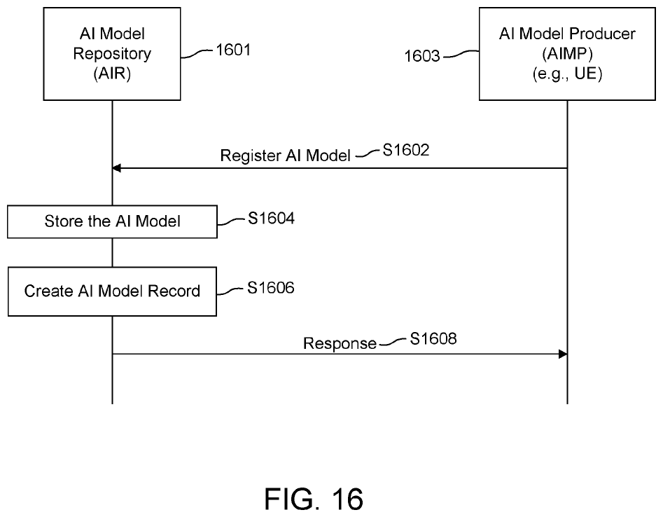

FIG. 16 illustrates a method for an AIMP to register an AI model to an AIR according to an embodiment of the present principles.

In step S1602, the AIMP 1603 sends a message to the AIR 1601 to register the AI model.

It is noted that the AIMP 1603 may have been informed of the address of the AIR 1601 when an AIM (not illustrated) installed an AI training task to the AIMP 1603. In this case, information included in the registration message, such as Trace-Instructions, may have been sent to the AIR 1601 by the AIM and can thus be omitted from the registration message.

The message may include:
Trace-Instructions: trace instructions and requirements on the AI model if an AIMU wants to use the model to infer knowledge. For example, one trace requirement may require the AIMU to record the inferred knowledge and associated input data for inference when the inferred knowledge is wrong or below certain accuracy threshold. This parameter is similar to Trace-Instructions as described in step 1208 in FIG. 12.
AI-Model-Type: the type of the AI model being registered. This could describe the type of the AI model in different levels or granularities such as but not limited to 1) algorithm-level: if the AI model is a linear regression model, a classification model, a DNN model, etc.; 2) application-level: if the AI model is for wireless channel prediction, image classification, pattern recognition, nature language processing, financial market prediction, autonomous driving, etc. If the AI model is a DNN model, AI-Model-Type can also indicate the number of layers and the number of neurons of the DNN.
AI-Model-Content: the full AI model (i.e., all parameters/weights of a DNN) and the model version, if the AI model being registered is fully trained. If the model is not fully trained, AI-Model-Content is not needed. Even for a fully trained AI model, the AIMP may skip this parameter and decide not to upload the model content to the AIR. Instead, other entities can discover the AI-Model-Address and use separate steps to retrieve the model content from the AIMP directly.
AI-Model-Usage-Constraints: constraints such as who and when the registered model can be discovered and used. As an example, AI-Model-Usage-Constraints may include a reputation threshold indicating only AIMUs with a reputation higher than the threshold can discover and use this AI model.
AI-Model-ID: the identifier of a previously registered AI model. The AIMP can use AI-Model-ID to inform the AIR that AI-Model-Content is an update to a previously registered AI model as denoted by AI-Model-ID
AI-Model-Address: the address of an AI model that is partially trained or still under training at the AIMP. With this parameter, the AIR or an AIMU can check the status of the AI model (e.g., fully trained or partially trained) from the AIMP, and download it from the AIMP after it is fully trained. If AI-Model-Content is not included in the registration message, an AIMU or the AIR can use AI-Model-Address to come to the AIMP to retrieve the model content at a later time.
AIM-ID: if the AI model training task at the AIMP was installed by an AIM, this parameter indicates the identifier and/or the address of the AIM.
AIMP-ID: identifier and/or address of the AIMP where the AI model is produced or still under training.

Step S1602 may be triggered when a new AI model is produced/trained at the AIMP 1603. Also, the AIMP 1603 can use step S1602 to pre-register or pre-announce an AI model that is still under training.

If AI-Model-Content is included in the message, in step S1604, the AIR 1601 stores the AI model in a (e.g., its local) repository. If AI-Model-Content is not included in the message, step S1604 can be skipped. If the AIMP 1603 requests to update a previously registered AI model in step S1602, the AIR 1601 uses the new AI-Model-Content included in the message in step S1602 to replace previous version of the AI model and remove the corresponding AI model record.

In step S1606, the AIR 1601 creates an AI model record for the AI model indicated the message in step S1602. The AIR 1601 may publish the AI model to a DSS (e.g., a distributed ledger). For example, the AIR 1601 may create a transaction including the AI model and send the transaction to the distributed ledger. The AI model record may include the following, which may be discovered and/or exposed to other entities such as AIMUs.
AI-Model-ID: same as in the message in step S1602, if included therein. If not included therein, this means that the AI model is first registered and the AIR 1601 will create AI-Model-ID for the registered AI model. Later, the AIMP 1603 can use AI-Model-ID to update a registered AI model.
AI-Model-Usage-Constraints: same as in the message in step S1602, if included therein. If not included therein, the AIR 1601 may determine AI model usage constraints.
AI-Model-Address: same as in the message in step S1602, if included therein. If not included therein, it is not needed.
AI-Model-Content: same as in the message in step S1602, if included therein. If not included therein, it is not needed.
AI-Model-Mode: indicates that the AI model is registered.
Trace-Instructions: same as in the message in step S1602.

In step S1608, the AIR 1601 sends a response to the AIMP 1603. The response may include:
AI-Model-ID: same as in step S1602.
AI-Model-Record-ID: identifier of the AI model record created in step S1606.

Upon reception of the response in step S1608, the AIMP 1603 may forward the response to an AIM (not illustrated), which has previously installed the AI task to the AIMP for training/producing the AI model being registered.

In case the AIM-ID was included in step S1602, the AIR 1601 may also forward the response sent to the AIMP 1603 in step S1608 to the AIM as denoted by AIM-ID. Upon reception of the response, the AIM can retrieve the AI model from the AIR 1601 or look up other information about the AI model at any time.

It is noted that the AIMP 1603 can use the method also to register its models to an AIM or a DSS (i.e., replace the AIR in FIG. 16 with the AIM or the DSS).

After step S1608, the AIR 1601 may send a notification containing the AI model record created in step S1606 to an AIM or an AITM.

It is noted that when an AIMP 1603 produces an AI model, it may send the AI model to the AIM. Then, the AIM can register the AI model to the AIR using the method in FIG. 16, interacting with the AIM instead of with the AIMP. Then, the AIM may publish the AI model to a DSS (e.g., a distributed ledger). For example, the AIM may create a transaction containing the AI model and sends the transaction to the distributed ledger.

It is noted that the AIR may forward Trace-Instructions as received from the AIMP to the AITM, especially when trace instructions are purely determined by the AIMP or when the AIR wants to verify Trace-Instructions with the AITM. When the AIR forwards Trace-Instructions, the AIR may associate Trace-Instructions with corresponding AI-Model-ID and AIMP-ID and also forward the associations to the AITM.

### Traceability-Aware AI Model Discovery and Deployment

### AIR-Assisted Traceability-Aware Model Discovery

An AIMU is to install an AI model. From an AIR, the AIMU discovers an AI model that meets its trace criteria. The AIR may send an AI model address to the AIMU or send the model content and associated trace instructions to the AIMU. If the AIMU only receives the AI model address from the AIR, the AIMU can retrieve the AI model content from the AI model address (e.g., an AIMP). The AIMU may also retrieve trace instructions from an AITM. Then, the AIMU installs the AI model incorporating the trace instructions and any user input. The AIMU creates an AI model record to the installed AI model. Finally, the AIMU sends the AI model record to the AIR and/or other entities (e.g., an AIMP, a DSS, an AITM).

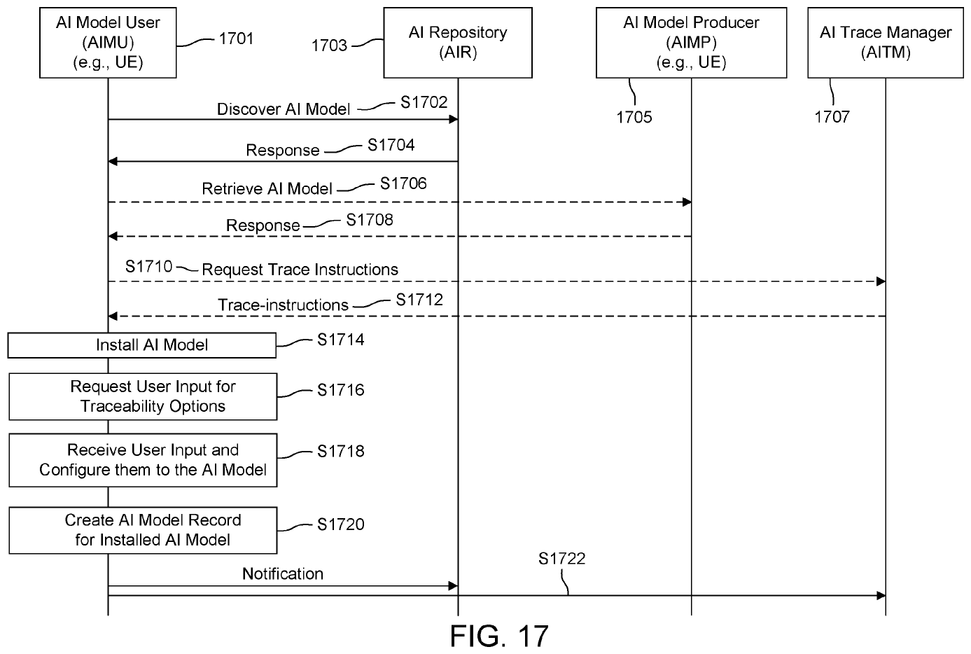

FIG. 17 illustrates a method of AIR-assisted traceability-aware model discovery and deployment according to an embodiment of the present principles.

An AIM (not illustrated) has installed an AI task without any associated AI model to an AIMU 1701. However, the AIMU 1701 needs an AI model to run the AI task to infer knowledge.

In step S1702, the AIMU 1701 sends a message to an AIR 1703 to discover its desired AI model(s). It is noted that the AIMU 1701 has a local AI agent, which has already been installed with the AI task when the AI task was installed, the address of an AIR 1703 can be configured to the AIMU 1701. This message may include one or more of:
Trace-Criteria: trace criteria for discovering AI models. In other words, the AIMU 1701 needs the AI models which “Trace-Instructions” meets the trace criteria as denoted by Trace-Criteria. Trace-Criteria may include similar information (e.g., “Trace-Scope”), which are a part of “Trace-Instructions” as described in step S1208 in FIG. 12.
AI-Model-Type: the type of the AI model being registered. This could describe the type of the AI model in different levels or granularities such as but not limited to: 1) algorithm-level: if the AI model is a linear regression model, a classification model, a DNN model, etc.; 2) application-level: if the AI model is for wireless channel prediction, image classification, pattern recognition, nature language processing, financial market prediction, autonomous driving, etc. If the AI model is a DNN model, AI-Model-Type can also indicate the number of layers and the number of neurons of the DNN.
AI-Model-ID: the identifier of a previously downloaded AI model. The AIMU 1701 can use this parameter to download a new version of the AI model from the AIR 1703.

It is noted that the AIMU 1701 may indicate in the message that Trace-Criteria is a secondary priority, which implies that an AI model with mismatched Trace-Instructions can still be discovered and installed to the AIMU 1701.

The AIR 1703 uses the received Trace-Criteria to check (locally) maintained AI model records to find any registered AI model with Trace-Instructions matching Trace-Criteria. For example, the AIR 1703 may check if “Trace-Scope” contained in Trace-Criteria matches “Trace-Scope” of Trace-Instructions of any maintained AI models. If AI-Model-ID is included in the message, the AIR 1703 can simply use it to find the corresponding AI model being registered.

In step S1704, the AIR 1703 sends a response to the AIMU 1701. The response may give the AIMU 1701 a full AI model with trace instructions. In a variant, the response includes only the AI model address information that the AIMU can use to download the full AI model. Specifically, the response may include the following information for each discovered AI model:
AI-Model-ID: the identifier of a discovered AI model.
AI-Model-Content: the content of the discovered AI model.
Trace-Instructions: the trace instructions that have been configured with the discovered AI model by an AIMP or an AIR.
AI-Model-Address: the address of a discovered AI model from which the content of the AI model can be retrieved. If this information is included, the AIMU 1701 may use it to retrieve the AI model from the AIMP, as will be described in steps S1706 and S1708.
AITM-ID: the identifier or address of an AITM, from which the AIMU 1701 can retrieve trace instructions for the AI model. If this information is included in the message in step S1702, the AIMU 1701 may perform steps S1710 and S1712, as will be described. The information can be omitted if Trace-Instructions is included in the response in step S1704.
Notification-Target: the address or identifier of one or multiple notification targets (e.g., the AIR, an AITM, etc.), to which the AIMU 1701 shall send a notification (i e, step 1722) after having installed the AI model.

It is noted that the AIR 1703 may find AI models without matching Trace-Instructions for the AIMU 1701, for example if the search is made without using Trace-Instructions or if no AI model matches the Trace-Instructions, especially when the AIMU 1701 indicated in the discover message in step S1702 that Trace-Criteria is a secondary priority. It is worth noting that the trace-instructions that the AIMU receives in the response in step S1704 may include additional tracing requirements (for example set by an AIMP) above those requested by the AIMU in the discover message in step S1702.

In case AI-Model-Address is included in the response in step S1704, the AIMU 1701 sends, in step S1706, a message to the AIMP 1705 to retrieve the AI model as denoted by AI-Model-Address. This message may include:
AI-Model-ID: as in step S1704.
AI-Model-Address: as in step S1704.
AI-Model-Push-Address: the address that the AIMP 1705 can use to push the content of a fully trained AI model to the AIMU 1701.

The AIMP 1705 can use AI-Model-ID and/or AI-Model-Address to uniquely identify an AI model the AIMP 1705 maintains locally.

The AIMP 1705 uses the received AI-Model-Address to identify the corresponding AI model and, in step S1708, sends a response to the AIMU 1701. If the AI model is fully trained now, the response includes the content of the AI model; otherwise, the response may include an indication that the AI model is not available and still under training. When the AI model is fully trained, the AIMP 1705 can push the content of the AI model to AI-Model-Push-Address. The response may include:
AI-Model-ID: as in step S1706.
AI-Model-Content: the content of the AI model if it is fully trained.
Trace-Instructions: the trace instructions and requirements required by the AI model if it is fully trained.
AI-Model-Ready-Time: an estimated time by which the AI model will be fully trained.
AITM-ID: the identifier or the address of an AITM, from which the AIMU 1701 can retrieve trace instructions from the AI model. If this parameter is included, the AIMU 1701 may perform steps S1710 and S1712 hereinafter.

In step S1710, the AIMU 1701 sends a request message to the AITM 1707 to retrieve trace instructions for an AI model in case the AIMU 1701 has obtained the content of the AI model in the response in step S1704 or S1708.

It is noted that step S1710 can be omitted in case, for example, the AIMU 1701 has received trace instructions from the AIR in the response in step S1704. In addition, in case the AIMU 1701 does not know the address or the identifier of the AITM 1707, step S1710 is omitted.

The request message may include:
AIMU-ID: the identifier of the AIMU 1701.
AI-Model-ID: the identifier of the AI model.
Trace-Criteria: same as “Trace-Criteria” in the request message in step S1702.
Trace-Capability: same as “Trace-Capability” received in step S1002 in FIG. 10.

The AITM 1707 determines trace instructions for the AIMU 1701, for example, based on the Trace-Criteria and Trace-Capability received in the request message in step S1710. Alternatively, the AIMU 1701 may have been provisioned with trace instructions for the AI model as denoted by AI-Model-ID. In step S1712, the AITM 1707 sends to the AIMU 1701 a response including the determined Trace-Instructions.

It is again noted that the AIMU 1701 itself can determine trace instructions from Trace-Instructions received in the response in step S1704 or S1708. In this case, steps S1710 and S1712 are not needed.

In step S1714, the AIMU 1701 installs the AI model as obtained in step S1704 or step S1708.

In step S1716, the AIMU 1701 may present Trace-Instructions as received in step S1712 or determined otherwise as already described, to a person to ask for input. For example, the person may accept or reject trace instructions, the person may specify the address to which the AIMU shall send AI trace records.

In step S1718, the AIMU 1701 may receive input from the person. The AIMU 1701 can generate final trace configuration (Trace-Configuration) by combining Trace-Instructions and the input from the person. The AIMU 1701 configures Trace-Configuration to the AI model.

In step S1720, the AIMU 1701 creates an AI model record for the installed AI model. The AI model record may include:
AIMU-ID: the identifier of the AIMU 1701.
AI-Model-ID: the identifier of the installed AI model.
AI-Model-Address: as in step S1704.
AI-Model-Push-Address: as in step S1706.
Trace-Configuration: the combined results of Trace-Instructions and the input from the person.

In step S1722, the AIMU 1701 sends a notification to the AIR or the AITM as determined by Notification-Target received in step S1704. The notification may include the whole AI model record created in step S1720 or the identifier of the AI model record. Optionally, the AIMU 1701 can also publish this AI model record to a DSS. Also, if the AI model was produced and contributed by an AIMP 1701, the AIMU 1701 may send the same notification to this AIMP 1705.

It is noted that another AIMP-X could use the method similar to that of FIG. 17 to discover and retrieve the content of an existing AI model, if it is to use the existing AI model as an initial model to train a new AI model, in which the AIMU is replaced by AIMP-X).

### AIM-Coordinated Traceability-Aware AI Model Discovery and Deployment

An AIMU relies on an AIM to discover at an AIR an AI model which meets its trace criteria. The AIR may return an AI model address to the AIMU or the model content and associated trace instructions to the AIM. If the AIM only receives the AI model address from the AIR, the AIM retrieves the AI model content from the AI model address (e.g., an AIMP). The AIM may also retrieve trace instructions from an AITM. Then, the AIM pushes the model content and the associated trace instructions to the AIMU. The AIMU installs the AI model incorporating the trace instructions and any user inputs. The AIM creates an AI model record for the installed AI model at the AIMU. Finally, the AIM sends the AI model record to the AIR and/or other entities (e.g., a DSS, the AIMP, an AITM).

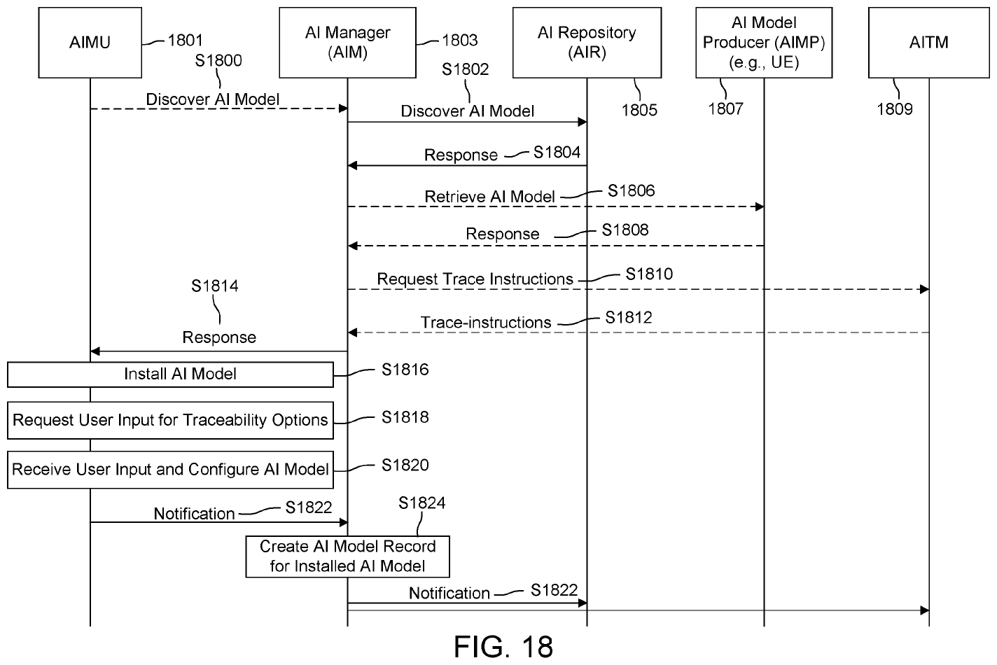

FIG. 18 illustrates a method of AIM-coordinated traceability-aware AI model discovery and deployment according to an embodiment of the present principles.

In step S1800, an AIMU 1801 may initiate to discover an AI model by sending a message to an AIM 1803. This is similar to step S1702 in FIG. 17. In addition, the AIMU 1801 may include its Trace-Capability in this step.

Since the AIM 1803 has installed an AI task to the AIMU 1801, it knows which kinds of AI models the AIMU 1801 requires. In step S1802, the AIM 1803 sends a message to the AIR 1805 for discovering and downloading an AI model for the AIMU 1801. This is similar to step S1702 in FIG. 17.

In step S1804, the AIR 1805 sends a response with AI model information to the AIM 1803, similar to step S1704 in FIG. 17.

In step S1806, the AIM 1803 sends a message to the AIMP 1807 to retrieve an AI model. This is similar to step S1706 in FIG. 17, but AI-Model-Push-Address included in the message can indicate either an address of the AIM 1803 for receiving the AI model from the AIMP 1807 or an address of the AIMU 1801 for receiving the AI model from the AIMP 1807. If AI-Model-Push-Address is the address of the AIMU 1801, the AIMP 1807 can directly push or send an AI model to the AIMU 1801 using this AI-Model-Push-Address.

In step S1808, the AIMP 1807 can send the requested AI model to the AIM 1803. This step is similar to step S1708 in FIG. 17.

In step S1810, the AIM requests Trace-Instructions from the AITM 1809. This is similar to step S1710 in FIG. 17.

In step S1812, having retrieved the Trace-Instructions, the AITM 1809 sends these to the AIM 1803. This is similar to step S1712 in FIG. 17.

Based on Trace-Instructions received in step S1804 and/or step S1812, the AIM 1803 determines the final trace instructions for the AI model to be deployed. In step S1814, the AIM 1803 sends a response message to the AIMU 1801 to instruct the AIMU 1801 to deploy the AI model. This message may include:
AI-Model-ID: the identifier of the AI model being sent to and deployed at the AIMU 1801.
AI-Model-Content: the content of the AI model being sent to and deployed at the AIMU 1801.
Trace-Instructions: the final trace instructions for the AI model to be sent to and deployed at the AIMU 1801.

In a variant, the AIM 1803 does not send Trace-Instructions to the AIMU 1801. Instead, the AIM 1803 may inform the AIMU 1801 of the identifiers of the determined or created trace instructions for the AIMU 1801 so that the AIMU 1801 can retrieve trace instructions from the AITM 1809, for example, by presenting its identifier and/or any identifier of the determined trace instructions.

In step S1816, the AIMU 1801 installs the AI model. This is similar to step S1714 in FIG. 17.

In step S1818, the AIMU 1801 requests user input for traceability options. This is similar to step S1716 in FIG. 17.

In step S1820, the AIMU 1801 receives user input and configures the AI model using final trace configuration determined using the user input. This is similar to step S1718 in FIG. 17.

In step S1822, the AIMU 1801 sends a notification message to the AIM 1803 indicating the deployment of the AI model. This notification message may include:
AIMU-ID: the identifier of the AIMU 1801.
Trace-Configuration: the final trace configuration as determined in step S1820.

In step S1824, the AIM 1803 creates an AI model record for the AI model deployed at the AIMU 1801. This is similar to step S1720 in FIG. 17. The AI model record may include:
AIMU-ID: the identifier of the AIMU 1801.
AI-Model-ID: the identifier of the installed AI model.
AI-Model-Address: the address for retrieving the AI model from the AIMP 1807.
AI-Model-Push-Address: same as in step S1806.
Trace-Configuration: same as in step S1822.
AIM-ID: the identifier of the AIM 1803.

In step S1826, the AIM 1803 sends a notification message to the AIR 1805 or the AITM 1809 as determined by Notification-Target as the AIMU received in the message in step S1804. The AIM 1803 may also determine to send the notification to the AIR 1805 and/or the AITM 1809 based on pre-configured polices. The notification may include the whole AI model record created in step S1824 or the identifier of this AI model record Optionally, the AIMU 1801 can publish this AI model record to a DSS. Also, if the AI model was produced and contributed by an AIMP 1807, the AIM 1803 may send the notification message to this AIMP 1807.

It is noted that another AIMP-Y could use the method illustrated in FIG. 18, taking the place of the AIMU, to discover and retrieve the content of an existing AI model, if it wants to use the existing AI model as an initial model to train a new AI model.

### AIMP-Initiated Traceability-Aware AI Model Discovery and Deployment

An AIMP is to deploy an AI model to AIMUs. From an AIR, the AIMP discovers an AIMU which meets its trace criteria and AI criteria. The AIR looks up its locally maintained AI host records and finds one or more AIMUs whose AI capability and trace capability match the AI criteria and trace criteria from the AIMP. The AIR returns the discovered AIMUs to the AIMP. Then, the AIMP contacts each AIMU to get their permission to deploy the AI model. The AIMU receives the model content from the AIMP and trace instructions from the AIMP or an AITM. Then, the AIMU installs the AI model incorporating the trace instructions and any user input. The AIMU creates an AI model record to the installed AI model. Finally, the AIMU sends the AI model record to the AIR and/or other entities (e.g., the AIMP, a DSS, an AITM).

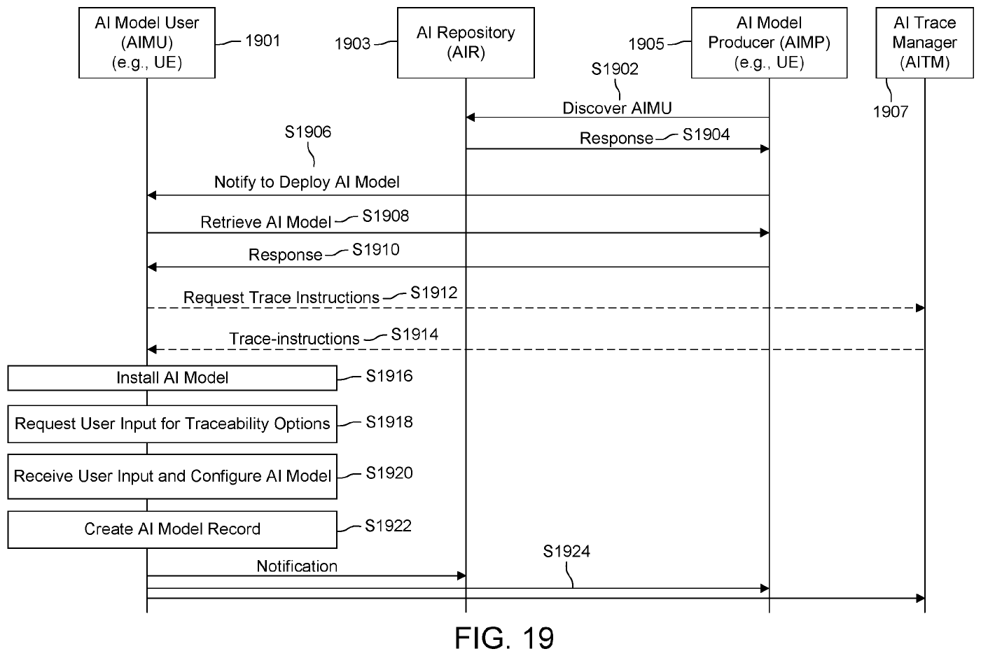

FIG. 19 illustrates a method of AIR-assisted traceability-aware model discovery and deployment according to an embodiment of the present principles.

In step S1902, an AIMP 1905 sends a message to an AIR 1903 to discover an AIMU 1901. This message may include:
AIMP-ID: (unique) identifier of the AIMP.
Trace-Criteria: trace criteria for discovering AIMUs. In other words, the AIMP discovers the AIMUs whose “Trace-Capability” meets the trace criteria as denoted by Trace-Criteria. Trace-Criteria may contain information (e.g., “Trace-Scope”) similar to that which is part of “Trace-Capability” as described for step S1208 of FIG. 12.
AI-Criterial: AI requirements for discovering AIMUs. In other words, the AIMP discovers the AIMUs whose “AI-Capability” meets the AI criteria as denoted by AI-Criteria. AI-Criteria may contain information similar to “AI-Capability” as described for step S1002 in FIG. 10. In addition, AI-Criterial may contain metadata about the AI model that the AIMP wants to deploy to AIMUs.

The AIR 1903 uses the received Trace-Criterial and AI-Criteria to check a (locally) maintained AI host record to find registered AIMU with Trace-Instructions matching Trace-Criteria. Then, in step S1904, the AIR 1903 sends a response to the AIMP 1905. The response message may include, for each discovered AIMU:
AIMU-ID: the identifier of a discovered AIMU, which may contain the address of the AIMU.
AI-Capability: the AI capability of the discovered AIMU.
Trace-Capability: the trace capability of the discovered AIMU.

Having received the response, the AIMP 1905 selects at least one AIMU from the list of discovered AIMUs included in the response in step S1904.

Steps S1906 to S1924 are performed for each selected AIMU.

In step S1906, the AIMP 1905 sends a notification to a selected AIMU 1901 to deploy an AI model. This notification message may include:
AIMU-ID: the identifier or the address of the selected AIMU 1901.
AI-Model-ID: the (unique) identifier of the AI model to be deployed.
AI-Model-Type: the type of the AI model to be deployed.
Trace-Criteria: the Trace-Criteria included in the message in step S1902.

The AIMU 1901 receives the notification message that it may accept or reject. In case the AIMU 1901 accepts the notification message, the method continues for that AIMU 1901.

In step S1908 the AIMU 1901 sends a message to the AIMP 1905 to retrieve the AI model identified by AI-Model-ID. This message may include:
AI-Model-ID: same as in step S1906.
AI-Model-Push-Address: the address that the AIMP 1905 can use to push the content of a fully trained AI model to the AIMU 1901.

The AIMP 1905 receives the message and uses AI-Model-ID to identify the corresponding AI model. In step S1910, the AIMP 1905 sends a response to the AIMU 1901.

In case the AI model is fully trained, the response can include the content of the AI model. Otherwise, the response can include information indicating that the AI model is not available and still under training. When the AI model is fully trained, the AIMP 1905 can also or alternatively push the content of the AI model to AI-Model-Push-Address. The response may include one or more of:
AI-Model-Content: the content of the AI model if it is fully trained.
Trace-Instructions: the trace instructions and requirements required by the AI model if it is fully trained. Note that the AIMP 1905 may obtain the trace instructions from an AITM 1907.
AI-Model-Ready-Time: an estimated time by which the AI model will be fully trained.
AITM-ID: the identifier or address of an AITM 1907, from which the AIMU 1901 can retrieve trace instructions from the AI model. In case this information is included in the response, the AIMU 1901 may perform steps S1912 and S1914.

Steps S1912 to S1922 are the same as steps S1710 to S1720.

In step S1924 is the same as step S1722 in FIG. 17 with the addition that the AIMU 1901 also sends the notification to the AIMP 1905.

### AIMP-Initiated Traceability-Aware AI Model Discovery and Deployment Implemented Using Distributed Ledgers

The method illustrated in FIG. 19 can be implemented using a blockchain and/or a distributed ledger as an example of a DSS, as will be described in the following example.

Each entity in FIG. 19 (i.e., the AIMU 1901, the AIR 1903, the AIMP 1905, and the AITM 1907) is a blockchain user. Each entity has a blockchain account. Each entity is connected to a different (or even the same) blockchain node which hosts the entire blockchain or ledger.

The AIR 1903 may have published AI host records onto a blockchain. The AIR 1903 may maintain the information about where each AI host record is stored in the blockchain (e.g., the sequence numbers of the block and the transaction containing the AI host record), referred to as the blockchain address of each AI host record.

The AIR 1903 (and/or the AIMP 1905) may have published AI model records onto a blockchain. The AIR 1903 may maintain the information about where each AI model record is stored in the blockchain (e.g., the sequence numbers of the block and the transaction containing the AI model record), referred to as the blockchain address of each AI model record.

The AITM 1907 may have published trace instructions onto the blockchain. The AITM 1907 may maintain the information about where each trace instruction is stored in the blockchain (e.g., the sequence numbers of the block and the transaction containing the trace instruction), referred to as the blockchain address of each trace instruction.

Step S1902 is unchanged.

In step S1904, the AIR 1903 can include only the blockchain address of the AI host record for the found AIMU in the response. In other words, this response does not contain AIMU-ID, Trace-Capability, and AI-Capability. The AIMP 1905 uses the blockchain address to retrieve the corresponding AI host record from the blockchain node, to which the AIMP 1905 connects.

In step S1906, the AIMP 1905 can include only the blockchain address of the AI model record.

In step S1908, the AIMU 1901 uses the blockchain address of the AI model to retrieve the AI model content and associated trace instructions from the blockchain node, to which the AIMU can connect.

In step S1910, the AIMU 1901 receives the AI model from the blockchain node.

Step S1912 is unchanged.

In step S1914, the response can include only the blockchain address of the trace instructions. Then, the AIMU 1901 uses this blockchain address to retrieve trace instructions from the blockchain node, to which the AIMU 1901 connects.

Steps S1916 to S1922 are unchanged.

Instead of, or in addition to, sending the notification in step S1924, the AIMU 1901 publishes the AI model record to the blockchain via the blockchain node, to which the AIMU connects. In an alternative, step S1924 is unchanged.

### EMBODIMENTS

The following illustrates how the present principles can be implemented in different kinds of network architectures.

### 3GPP SA2 Embodiment

### Architectural Embodiment

The entities for traceability-aware AI task and model management described herein (e.g., AIMU, AIR. AIMP and AITM) can be implemented in 3GPP cellular networks as follows using 5G service architecture as a non-limitative example.

An AIMU can be a UE, a Network Function (NF), and/or an Application Function (AF).

An AIMP can be a UE, an NF, and/or an AF.

An AIM and an AIR can be integrated in one device or node as an AI Management and Repository Function (AIMRF) that can be deployed as a standalone NF, an AF, an extension to 5G Network Repository Function (NRF), an extension to 5G Network Data Analytics Function (NWDAF), or an extension to 5G Unstructured Data Storage Function (UDSF).

An AITM can be implemented as an AI Trace Management Function (AITMF) that can be deployed as a standalone NF or an extension to 5G Policy Control Function (PCF).

A DSS can be implemented as a DSS Function (DSSF) deployed as a standalone NF, an extension to 5G Unified Data Repository (UDR) function, or an extension to 5G UDSF.

The AIMU, AIMP, AIMRF, AITMF, and DSSF can be deployed in various locations of 5G and beyond cellular networks, such as device, edge data networks, core network, data network and/or the cloud.

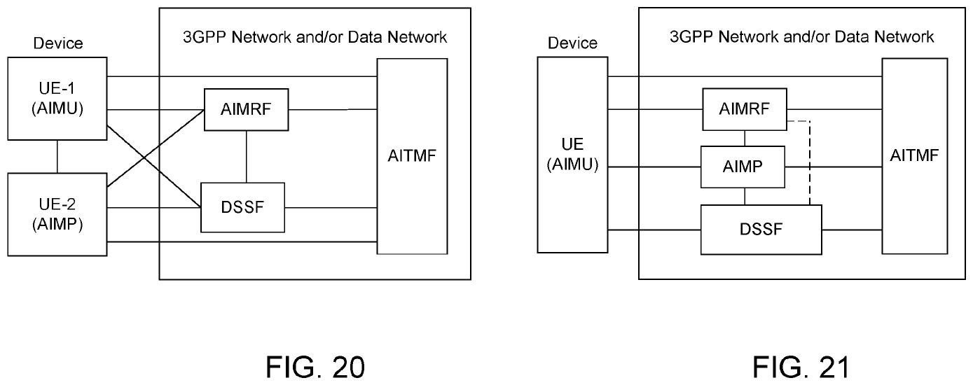

FIG. 20 illustrates an example of deployment of traceability-aware AI task and model management in 3GPP cellular networks. In this example:
UE-1 is an AIMU hosting an AI task, which uses an AI model provided by AIMP for knowledge inference. UE-1 has its AI-Capability and Trace-Capability.
UE-2 is an AIMP hosting an AI task, which produces an AI model. The produced AI model is deployed to UE-1. UE-1 has its AI-Capability and Trace-Capability.
AIMRF is deployed as an NF or an AF in 3GPP network or data network. UE-1 registers itself to AIMRF as an AIMU indicating its AI-Capability and Trace-Capability, while UE-2 registers itself to AIMRF as an AIMP and indicates its AI-Capability and Trace-Capability too. AIMRF maintains a list of registered AIMUs and AIMPs; alternatively, AIMRF publishes/stores registered AIMUs and AIMPs to DSSF.
AITMF is deployed as an NF or an AF in 3GPP network or data network to manage trace instructions. AITMF can determine appropriate Trace-Instructions for UE-1 and UE-2. AITMF can store Trace-Instructions to DSSF and can also retrieve Trace-Instructions from DSSF.
The information about registered AIMUs, registered AIMPs, registered AI models, deployed AI tasks, and/or trace instructions can be stored in and maintained by DSSF.

The AIMRF is responsible for deploying an AI task to UE-2 for training an AI model. When AIMRF deploys an AI task to UE-2, it may assign Trace-Instructions with the AI task. Such trace instructions may be obtained from AITMF.

After UE-2 produces an AI model, UE-2 registers the AI model to AIMRF. When UE-2 registers its AI model, it can indicate Trace-Instructions associated with the AI model. AIMRF maintains a list of registered AI model and each registered AI model may have associated Trace-Instructions.

The AIMRF is also responsible for deploying an AI task to UE-1 for using an AI model for knowledge inferring. When AIMRF deploys an AI task to UE-1, it may configure the AI task with Trace-Instructions. Such Trace-Instructions may be obtained from AITMF.

UE-1 can discover an AI model (e.g., the AI model produced by UE-2) from AIMRF. AIMRF guarantees that UE-1's Trace-Capability matches Trace-Instructions of a discovered AI model.

The AIMRF can push a discovered AI model with its Trace-Instructions to UE-1. Also, UE-1 can use separate steps to retrieve/pull the discovered AI model and its Trace-Instructions from AIMRF.

Alternatively, UE-2 can find UE-1 from AIMRF and actively push an AI model with Trace-Instructions to UE-1.

FIG. 21 illustrates another example of deployment traceability-aware AI management in 3GPP cellular networks. In this example, the AIMU is still a UE, but the difference to FIG. 20 is that the AIMP is an NF or an AF in 3GPP network or Data Network.

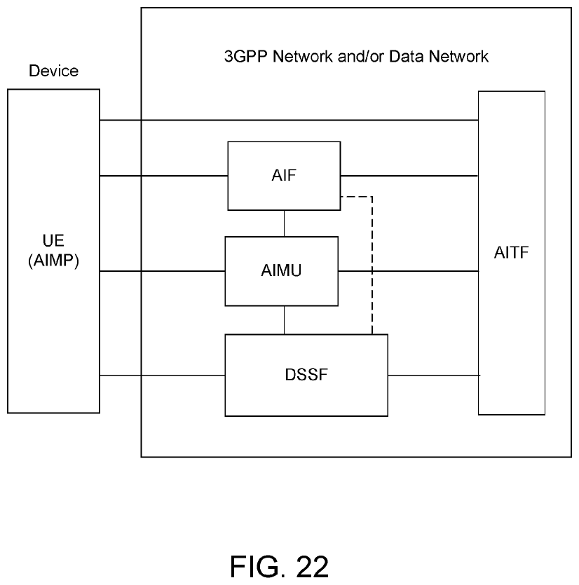

FIG. 22 illustrates another example of deployment traceability-aware AI management in 3GPP cellular networks. In this example, AIMP is still a UE, but the difference to FIG. 20 is that the AIMU is an NF or an AF in 3GPP network or Data Network.

### Service Flow Embodiment for Traceability-Aware AI Model Discovery and Deployment

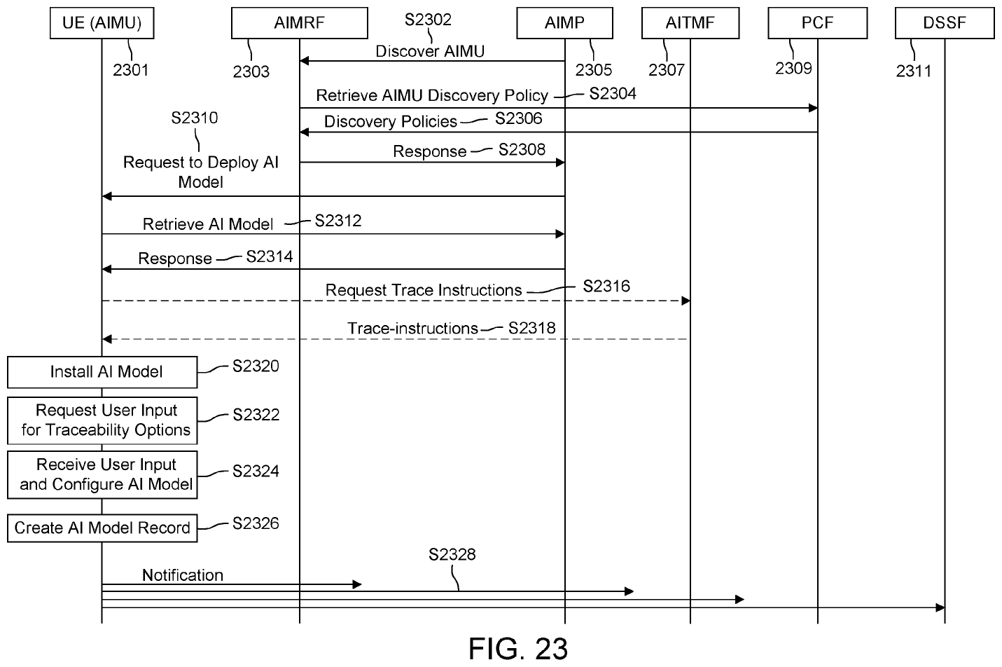

FIG. 23 illustrates an example of service flow for traceability-aware AI model discovery and deployment, based on the procedure in FIG. 19. Note that AIMU-ID in FIG. 23 is the UE identifier such as but not limited to the UE's Global Unique Temporary Identifier (GUTI), the UE's Subscription Concealed Identifier (SUCI), etc.

The following is assumed. An AIMP inside 3GPP core network trains a new AI model for efficient radio resource allocation for upstream communications. The AIMP is to deploy the AI model to a UE as an AIMU. In the meantime, the AIMP wants to know if the AI model is accurate or useful for the UE and the whole system. In other words, the AIMP wants the UE to trace the AI model once it is deployed and executed. First, the AIMP finds an appropriate UE from an AIMRF, which has its Trace-Capability matching the AIMP's Trace-Criteria. Then, the AIMP may determine trace instructions by itself, or the AIMP can obtain the trace instructions from an AITMF. Last, the AIMP deploys the AI model with the corresponding trace instructions to the UE.

The following pre-conditions may be assumed for FIG. 23:
An AIMRF, an AITMF, a DSSF, an AIMP and a PCF have registered to an NRF.
The AIMP has found an AIMRF, an AITMF, and a PCF.
A UE has been registered to the 3GPP cellular network and can communicate with core network functions such as AIMRF via an AMF (not illustrated).
Both UE and the AIMP have been registered to AIMRF.
The AIMP produces an AI model.

The service flows in FIG. 23 will now be described.

In step S2302, the AIMP 2305 sends a request to AIMRF 2303 to discover an AIMU in order to deploy the AI model to the AIMU 2301.

In step S2304, the AIMRF 2303 sends a message to check with the PCF 2309 if there are any AIMU discovery policies applicable for the AIMP 2305.

In step S2306, the PCF 2309 sends AIMU discovery policies to the AIMRF 2305.

The AIMRF 2303 authorizes the AIMP's request received in step S2302. In case it is approved, the AIMRF 2303 finds one or multiple AIMU 2301 from its locally maintained AIH records. In step S2308, the AIMRF 2303 sends the discovered AIMUs to the AIMP 2305 (i.e., UE in this case).

In step S2310, the AIMP 2305 sends a request message to UE 2301 to deploy an AI model.

The UE 2301 approves the received request. (If it does not, the service flow stops.) In step S2312, the UE 2301 sends a request to the AIMP 2305 to retrieve the AI model.

In step S2314, the AIMP 2305 sends the content of the AI model with trace instructions to UE 2301.

In step S2316, the UE 2301 may send a request to the AITMF 2309 to retrieve trace instructions for the AI model. In this case, in step S2318, the AITMF 2309 sends the requested trace instructions to UE 2301.

In step S2320, the UE 2301 installs the AI model.

In step S2322, the UE 2301 requests user input for traceability options.

In step S2324, the UE 2301 receives user input and uses this to configure the AI model.

In step S2326, the UE 2301 creates an AI model record for the installed AI model.

In step S2328, the UE 2301 sends the AI model record to the AIMRF 2303, the AIMP 2305, the AITMF 2307, and/or the DSSF 2311.

### ETSI SAI Embodiment

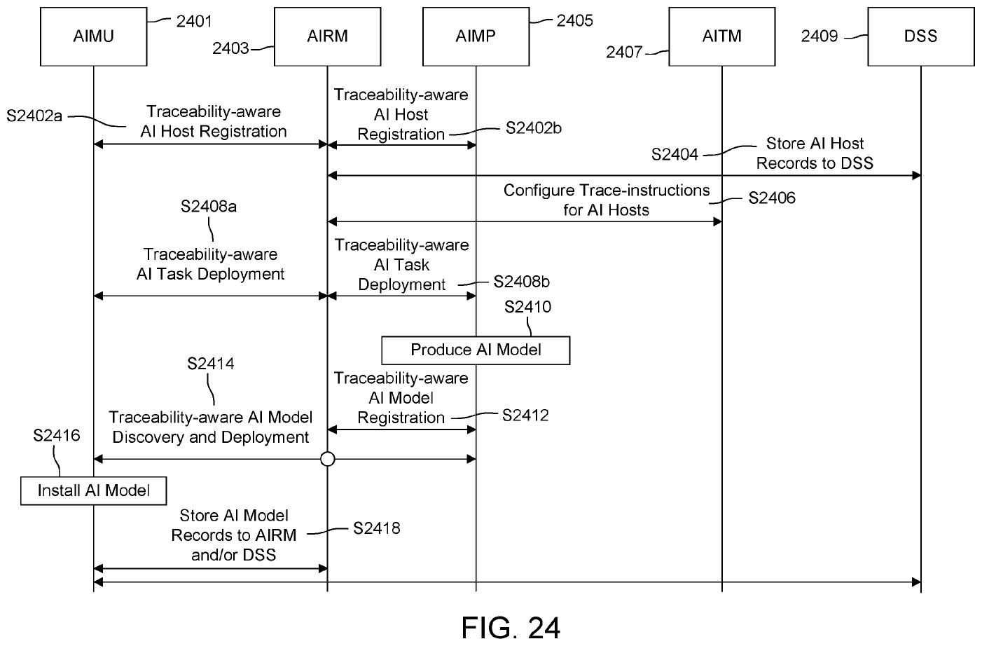

FIG. 24 illustrates an example of a method of traceability-aware AI task and model deployment according to the present principles implemented in the framework of ETSI SAI including the following logical entities:
AIMU: same as AIMU in FIG. 7.
AIMP: same as AIMP in FIG. 7.
AITM: same as AITM in FIG. 7.
DSS: same as DSS in FIG. 7.
AIRM: combination of AIR and AIM in FIG. 7.

In step 2402a, the AIMU 2401 registers itself to AIRM 2403 indicating its Trace-Capability using steps S1002, S1004 and S1006 in FIG. 10. In step 2402b, the AIMP 2405 registers itself to AIRM 2403 indicating its Trace-Capability using steps S1002, S1004 and S1006 in FIG. 10.

In step 2404, the AIRM 2403 generates AI Host Records (i.e., the registration record for AIMU and AIMP) to DSS 2409.

In step 2406, the AIRM 2403 requests Trace-Instructions for the registered AIMP 2405 and AIMU 2401 from the AITM 2407, for instance, based on their Trace-Capability.

In step 2408a, the AIRM 2403 deploys an AI task to the AIMU 2401. In step 2408b, the AIMR 2403 also deploys an AI task to AIMP 2405. The same steps from either FIG. 12, FIG. 13, FIG. 14, or FIG. 15 can be used for step 2408a and 2408b.

In step 2410, the AIMP 2405 uses the deployed AI task to train and produce an AI model.

In step 2412, the AIMP 2405 registers the produced AI model indicating its Trace-Instructions. The same steps from FIG. 16 can be used for step 2412.

In step 2414, possibly via the AIRM 2403, the AIMP 2405 deploys the produced AI model to the AIMU 2401. The AIMP 2405 can directly install the AI model to AIMU 2401. Alternatively, AIMU 2401 can discover and download the AI model from AIRM 2403. The same steps from either FIG. 17, FIG. 18, or FIG. 19 can be used for step 2414.

In step 2416, the AIMU 2401 installs the AI model and configures associated Trace-Instructions.

In step 2418, the AIMU 2401 generates an AI model record for the installed AI model. The AIMU 2401 sends the AI model record to AIRM 2403 and/or DSS 2409.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UJE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A device comprising:
at least one processor configured to:
receive, from at least one other device, an Artificial Intelligence, AI, model for installation on the device to perform an AI task, and information indicative of trace instructions based on trace criteria for the AI model requested by the device, wherein the trace information corresponds to information for tracing one or more stages of an AI pipeline associated with the AI model;
install the AI model;
create a record for the installed AI model; and
transmit a message to a record device, the message comprising information indicative of at least part of the created record.

2. The device of claim 1, wherein the at least one processor is configured to transmit, to at least one of the at least one other device, information indicative of a request for an AI model, the request comprising the trace criteria.

3. The device of claim 1, wherein the request further comprises an identifier of the AI model.

4. The device of claim 1, wherein the at least one processor is configured to:
receive, from a first device of the at least one other device, information indicative of a second device;
wherein the at least one processor is configured to receive the AI model by downloading the AI model from the second device.

5. The device of claim 4, wherein the at least one processor is configured to:
receive, from the first device, information indicative of a third device; and
transmit, to the third device, information indicative of a request for the trace instructions.

6. The device of claim 1, wherein the at least one processor is configured to:
receive, from a first device, information indicative of a third device; and
transmit, to the third device, information indicative of a request for the trace instructions.

7. The device of claim 1, wherein the at least one processor is configured to:
create the record using a trace configuration based on the trace instructions.

8. The device of claim 7, wherein the at least one processor is configured to:
present the trace instructions to a user;
receive input from the user; and
generate the trace configuration based on the trace instructions and the input from the user.

9. (canceled)

10. The device of claim 1, wherein the created record for the installed AI model comprises at least one of an identifier of the device, an identifier of the installed AI model, an address from which the AI model can be retrieved, and an address that can be used to push a fully trained AI model to the device.

11. A method, performed by a device, the method comprising:
receiving, from at least one other device, an Artificial Intelligence, AI, model for installation on the device to perform an AI task, and information indicative of trace instructions based on trace criteria for the AI model requested by the device, wherein the trace information corresponds to information for tracing one or more stages of an AI pipeline associated with the AI model;
installing the AI model;
creating a record for the installed AI model; and
transmitting a message to a record device, the message comprising information indicative of at least part of the created record.

12. The method of claim 11, further comprising transmitting, to at least one of the at least one other device, information indicative of a request for an AI model, the request comprising the trace criteria.

13. The method of claim 11, wherein the request further comprises an identifier of the AI model.

14. The method of claim 11, further comprising:
receiving, from a first device of the at least one other device, information indicative of a second device;
wherein receiving the AI model comprises downloading the AI model from the second device.

15. The method of claim 14, further comprising:
receiving, from the first device, information indicative of a third device; and
transmitting, to the third device, information indicative of a request for the trace instructions.

16. The method of claim 11, further comprising:
receiving, from a first device, information indicative of a third device; and
transmitting, to the third device, information indicative of a request for the trace instructions.

17. The method of claim 11, further comprising:
creating the record using a trace configuration based on the trace instructions.

18. The method of claim 17, further comprising:
presenting the trace instructions to a user;
receiving input from the user; and
generating the trace configuration based on the trace instructions and the input from the user.

19. (canceled)

20. The method of claim 11, wherein the created record for the installed AI model comprises at least one of an identifier of the device, an identifier of the installed AI model, an address from which the AI model can be retrieved, and an address that can be used to push a fully trained AI model to the device.

21. A device comprising:
at least one processor configured to:
receive, from another device, an Artificial Intelligence, AI, model for installation on the device to perform an AI task, and information indicative of trace instructions for the AI model, the trace instructions corresponding to information for tracing one or more stages of an AI pipeline associated with the AI model;
install the AI model; and
transmit a message to the other device, the message comprising information indicative of installation of the AI model on the device.

22-24. (canceled)

25. A method, performed by a device, the method comprising:
receiving, from another device, an Artificial Intelligence, AI, model for installation on the device to perform an AI task, and information indicative of trace instructions for the AI model, the trace instructions corresponding to information for tracing one or more stages of an AI pipeline associated with the AI model;
installing the AI model; and
transmitting a message to the other device, the message comprising information indicative of installation of the AI model on the device.

26-28. (canceled)
